(19) United States
(12) Patent Application Publication
(10) Pub. No.: US 2026/0065085 A1
(43) Pub. Date: Mar. 5, 2026

(54) AI-POWERED REQUEST ENRICHMENT SYSTEM AND INTERFACE AGENT FOR LEDGER OPERATIONS

(71) Applicant: Oracle International Corporation, Redwood Shores, CA (US)

(72) Inventors: Sundarraman Narayanan, Redwood City, CA (US); Linda S. Wong, Belmont, CA (US); Shyam Sundar Santhanam, Pleasanton, CA (US); Rondy Ng, Redwood City, CA (US); Harshavardhan Takle, Foster City, CA (US)

(73) Assignee: Oracle International Corporation, Redwood Shores, CA (US)

(21) Appl. No.: 19/181,612

(22) Filed: Apr. 17, 2025

Related U.S. Application Data
(60) Provisional application No. 63/690,765, filed on Sep. 4, 2024.

(51) Int. Cl. G06N 5/022

(52) U.S. Cl. CPC G06N 5/022

(57) ABSTRACT

Systems, methods, and computer-readable media are provided for accessing a user request received in a user session with an application. Item(s) of data may be selected in the user session in association with the user request. A data management system determines that the request is for or otherwise relevant to item(s) of application functionality such as financial exceptions, account balances, and/or operations detail. The data management system generates a prompt by adding structured data return template(s) for triggering the item(s) of application functionality, the user request, and, if applicable, structured text representing the item(s) of data to a prompt template. The data management system prompts a large language model with the prompt and receives a result. The result includes a data structure conforming to the structured data return template(s) and that is based at least in part on the item(s) of data. The data management system triggers the relevant item(s) of application functionality based at least in part on the result and causes display of information indicating the item(s) of application functionality have been triggered.

### CROSS-REFERENCE TO RELATED APPLICATION(S)

This application claims the benefit of U.S. Provisional Patent Application No. 63/690,765, filed on Sep. 4, 2024. The entire disclosure of the aforementioned application is incorporated by reference herein in its entirety for all purposes.

### BACKGROUND

Data is analyzed in browser-based applications and other applications that provide user interfaces to create, review, or modify data. The user interfaces may be displayed on client devices such as laptops or smartphones that are running a browser that operates according to application instructions or that are operating an installed program at the operating system level. User interfaces allow users to click on buttons to navigate the interface and view and edit fields that are made available through the interface.

### BRIEF SUMMARY

In some embodiments, a computer-implemented method includes accessing a user request, such as a request stated in natural language as typed or spoken by the user, received in a user session with an application. Item(s) of data may be selected in the user session in association with the user request. The method further includes determining that the request is for or otherwise relevant to item(s) of application functionality, for example, among many items of application functionality that are available to be triggered. The method includes generating a prompt by adding structured data return template(s) for triggering the relevant item(s) of application functionality, the user request, and, if applicable, structured text representing the item(s) of data to a prompt template. The method includes prompting a large language model with the prompt and receiving a result. The result includes a data structure conforming to the structured data return template(s) and that is based at least in part on the item(s) of data. The method includes triggering the item(s) of application functionality based at least in part on the result and causing display of information indicating the item(s) of application functionality have been triggered.

In one embodiment, a computer-implemented method comprises accessing a natural language user request received in a user session with an application. The natural language user request is stored in association with one or more items of data that have been selected in the user session. The computer-implemented method further includes determining that a particular structured data return template, of a plurality of stored structured data return templates, is relevant to the request. The particular structured data return template is configured to trigger a particular item of application functionality that is different than one or more other items of application functionality which one or more other structured data return templates of the plurality of stored structured data return templates are configured to trigger. The computer-implemented method further includes generating a prompt by adding the particular structured data return template for triggering the particular item of application functionality, structured text representing the one or more items of data in a multidimensional context, and the natural language user request to a prompt template. The computer-implemented method further includes prompting a large language model with the prompt. The computer-implemented method further includes receiving a result of the prompt, the result comprising a data structure conforming to the structured data return template and that is based at least in part on the one or more items of data in the multidimensional context. The computer-implemented method further includes triggering the particular item of application functionality based at least in part on the data structure. The computer-implemented method further includes causing display of information indicating the particular item of application functionality has been triggered.

In a further embodiment, the one or more items of data are selected by being highlighted in the user session as the user request is submitted as text input.

In the same or a different further embodiment, the one or more items of data are selected by being dragged into an input field, and the computer-implemented method further includes causing display, in the input field, of a graphical object representing the one or more items of data. The graphical object indicates that information about the one or more items of data are included with the user request upon submission. The computer-implemented method further includes receiving the user request as text added to the input field.

In the same or a different further embodiment, the particular structured data return template is stored separately from the prompt template, and the prompt template supports a plurality of different structured data return templates that are selectable depending on the user request.

In the same or a different further embodiment, the computer-implemented method further includes determining that the particular structured data return template is relevant to the user request based at least in part on a semantic similarity of the user request to a content embedding stored for matching the particular structured data return template to user requests.

In the same or a different further embodiment, the computer-implemented method further includes determining that the particular structured data return template is relevant to the user request based at least in part on another prompt to the large language model, the other prompt asking which of a specified set of different items of application functionality the user request is attempting to trigger.

In the same or a different further embodiment, the computer-implemented method further includes retrieving the structured text representing the one or more items of data based at least in part on a REST call to access a data repository.

In the same or a different further embodiment, the data structure conforming to the particular structured data return template triggers a REST call to access a data repository and retrieve one or more data values to perform one or more operations on the one or more data values.

In the same or a different further embodiment, the data structure conforming to the particular structured data return template triggers a REST call to create one or more objects in a data repository and navigate to one or more user interfaces to analyze the one or more created objects.

In the same or a different further embodiment, the data structure conforming to the particular structured data return template triggers creation of one or more objects in a data repository and causes an option to be displayed for confirming the one or more objects.

In the same or a different further embodiment, the accessing the natural language user request is performed by a supervisor agent. The generating the prompt and the prompting the large language model are performed by a particular worker agent based on information provided by the supervisor agent. The method further includes selecting one or more worker agents, including the particular worker agent, of a plurality of worker agents for the natural language user request based at least in part on a context of the natural language user request. In a further embodiment, the supervisor agent is a ledger insights monitor supervisor agent that tracks criteria and governs insights, and the one or more worker agents include a ledger insights tracker worker agent that monitors insights criteria and generates insights and alerts and an insights explorer worker agent that generates one or more views showing data sets of a particular granularity. The causing display of the information comprises causing display of the one or more views.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that uses structured data return template(s) for triggering application functionality and/or uses information about item(s) of data selected in a user session to enrich a prompt to a large language model for determining a data-driven response to a user request.

FIG. 2 illustrates a system diagram showing an example system for using structured data return template(s) for triggering application functionality and/or using information about item(s) of data selected in a user session to enrich a prompt to a large language model for determining a data-driven response to a user request.

FIG. 3 depicts an example user interface showing an example new journal entry template.

FIG. 4 depicts an example user interface showing an example landing screen for an application platform that provides various modes of data management access.

FIG. 5 depicts an example user interface showing an example view of multidimensional data based at least in part on a notification or detected anomaly.

FIG. 6 depicts an example user interface showing an example selection of a particular item of multidimensional data in a user session.

FIG. 7 depicts an example user interface showing an example dragging of a particular item of multidimensional data along with summary information about the item.

FIG. 8 depicts an example user interface showing an example dragging of a particular item of multidimensional data to a user input region.

FIG. 9 depicts an example user interface showing an example item of multidimensional data adjacent to natural language user input in the user input region.

FIG. 10 depicts an example user interface showing an example result of a user request to analyze an item of multidimensional data.

FIG. 11 depicts an example user interface showing an example selection of items of multidimensional data in a user session.

FIG. 12 depicts an example user interface showing an example natural language query that is entered for submission with selected text and a named application functionality template in a user session.

FIG. 13 depicts an example user interface showing an example result of performing application functionality according to the named application functionality template in response to the user request based on a data structure generated by a large language model.

FIG. 14 depicts a simplified diagram of a distributed system for implementing certain aspects.

FIG. 15 is a simplified block diagram of one or more components of a system environment by which services provided by one or more components of an embodiment system may be offered as cloud services, in accordance with certain aspects.

FIG. 16 illustrates an example computer system that may be used to implement certain aspects.

### DETAILED DESCRIPTION

A description of a data management system is provided, such that the data management system uses structured data return template(s) for triggering application functionality and/or uses information about item(s) of data selected in a user session to enrich a prompt to a large language model for determining a data-driven response to a user request. The description is provided in the following sections:
ACCESSING DATA VIA A USER INTERFACE
RECEIVING A SELECTION OF DATA RELEVANT TO A USER REQUEST
DETERMINING THE USER REQUEST IS FOR A PARTICULAR ITEM OF APPLICATION FUNCTIONALITY.
PROMPTING A LARGE LANGUAGE MODEL
CONSUMING A DATA STRUCTURE GENERATED BY THE LARGE LANGUAGE MODEL TO TRIGGER RESPONSIVE ACTIONS
MULTI-AGENT ARCHITECTURE FOR ENRICHING APPLICATION FUNCTIONALITY AND/OR DATA INSIGHTS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Techniques disclosed herein provide a data management system to efficiently manage day-to-day operational accounting activities. The ledger agent identifies operational exceptions from transaction processing, and insights and anomalies from transactional data. This eliminates tedious manual effort of having to sift through high volumes of operational data in the General Ledger and supporting accounting data to find these exceptions, insights and anomalies. The ledger agent allows accounting professionals to interact with financial data via natural language prompts and the agent responds real-time with the information requested. The ledger agent discovers account reconciliation differences, unusual data patterns in financial transactions, variances in data comparisons, situations involving missing or invalid data, and processing exceptions. The ledger agent collects operational data on transactions that are still in-flight, or have not yet completed their transaction lifecycle, such as for sales orders, subscriptions, customer invoices, customer payments, purchase orders, receipt costing, supplier invoices, supplier payments, payroll, inventory costing, project costing, project billing and other business transactions, to provide accountants with up-to-date information without having to wait until the end of the month or quarter. The ledger agent uses the collected transactional information to create supporting true-up journal entries like accruals, reconciliation entries, and topside adjustments.

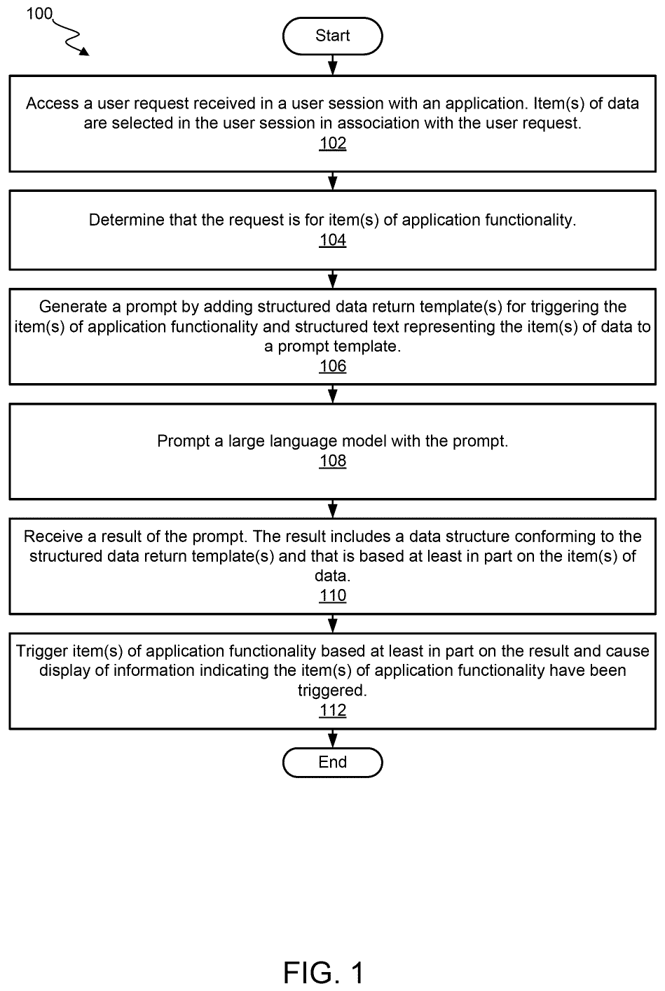

FIG. 1 illustrates a flow chart of an example process that uses structured data return template(s) for triggering application functionality and/or uses information about item(s) of data selected in a user session to enrich a prompt to a large language model for determining a data-driven response to a user request. The user request may be stated in natural language as typed, spoken, or otherwise input by the user. Optionally, spoken text may be transcribed, and any input text may be further processed or transformed to better conform the input text with downstream processing (e.g., by correcting spelling or grammar, and/or identifying and correcting object references within the text based on a known schema of objects). As shown, a data management system accesses a user request received in a user session with an application. Item(s) of data may be selected in the user session in association with the user request. For example, the user session may include one or more interfaces to analyze insights, such as anomalies, exceptions, combinations or patterns detected in data, or other organizations of operational data, and data selected from the one or more interfaces may be stored in association with the user request. For example, the user request and the item(s) of data may be included in a prompt to a large language model to trigger application functionality with respect to the item(s) of data and in line with or according to the user request.

A data management system determines that the request is for or otherwise relevant to item(s) of application functionality, for example, among many items of application functionality that are available to be triggered. The data management system generates a prompt by adding structured data return template(s) for triggering the item(s) of application functionality, the user request, and, if applicable, structured text representing the item(s) of data to a prompt template. The data management system prompts a large language model with the prompt and receives a result. The result includes a data structure conforming to the structured data return template(s) and that is based at least in part on the item(s) of data. The data management system triggers the item(s) of application functionality based at least in part on the result and causes display of information indicating the item(s) of application functionality have been triggered.

In various embodiments, a user interface is displayed to a user, and a user expresses an interest or makes a selection to analyze a set of one or more data items by interacting with the user interface. The selection of the set of data items and/or a specified or submitted user request may initiate a process to prompt a large language model to provide additional functionality relevant to the set of data items, supporting additional analysis relevant to the set of data items. Results from the large language model may be ingested by an agent supporting the interface to cause display of information relevant to the set of data items and/or any insights relevant to the set of data items or other related data items or insights. For example, the insights may include forecasts, predictions, analysis, or additional details relevant to the set of data items.

In one embodiment, the data management system may include, in the prompt, sufficient information about other items of multidimensional data such that an anomaly or exception analysis agent may identify potential causes of anomalous data that has been selected, and/or other anomalies that are relevant to, co-occurring, and/or correlated with the items of data that were selected. In this manner, in addition or alternative to triggering targeted functionality relevant to the user query to drill into data relevant to a displayed insight or base insight, the data management system may identify secondary or contextual insights that are relevant to the base insight. These secondary insights may be displayed for user consumption before or after a user request has been made, as items are selected in the interface or even after additional targeted functionality has been triggered for data relevant to the base insight. For example, a user may have selected to analyze a variance in sales for a particular division of the company in a particular quarter, as a result of a base insight highlighting the variance of the particular division as anomalous, without realizing that two other divisions of the company also had variances in sales in the particular quarter. A user request to analyze the particular division may be handled to cause application functionality with respect to the particular division, and the data management system may also display information about the two other divisions of the company that also had anomalous or nearly anomalous data for the same or a similar period.

The data management system may automatically append these additional secondary insights to the prompt to cause the LLM to answer a question broader than the user request, optionally without additional user input and optionally without selection or even display of the other items of data relevant to the secondary insights. For example, this may allow the LLM to reason that other data items relevant to the secondary insights are a potential cause of anomalies reflected by selected data items relevant to the base insight, and/or that the other data items relevant to the secondary insights contribute to the same over-arching issue as the selected data items relevant to the base insight.

In the same or a different embodiment, the data management system may prompt the LLM for targeted additional functionality with respect to any selected items of data and cause display of additional information in response to the user request, the additional information identifying other items of data relevant to secondary insights. In a further embodiment, the data management system may also display an option to include the other items of data in the targeted additional functionality or exclude the other items of data from the targeted additional functionality. Depending on user selection of the option, the data management system may undo or redo the targeted item(s) of application functionality with the other items of data from the secondary insights included or excluded.

In various embodiments, insights such as exceptions or anomalies may be defined based on conditions that may be satisfied by selected data items and/or other data items that are not selected. The conditions may be customized in a configuration user interface that defines when to notify a user and/or trigger further analysis of data via an insights user interface. For example, a user may specify condition(s) that indicate which value(s) of a multidimensional dataset to monitor for anomalies, and a sensitivity of alerts for the potential anomalies based on a user preference to avoid false positives (less sensitive alerts) or avoid false negatives (more sensitive alerts). Such preferences may be specified on a dimension-specific, field-specific, and/or user-specific basis, optionally with a sliding scale between a most sensitive setting and a least sensitive setting. In one embodiment, the preferences may be specified in natural language, such as in text input or an imported text document, with the data management system determining which field(s) and dimension(s) are referenced by the natural language request to monitor for anomalies, and how sensitive such anomaly monitoring should be based on the natural language request.

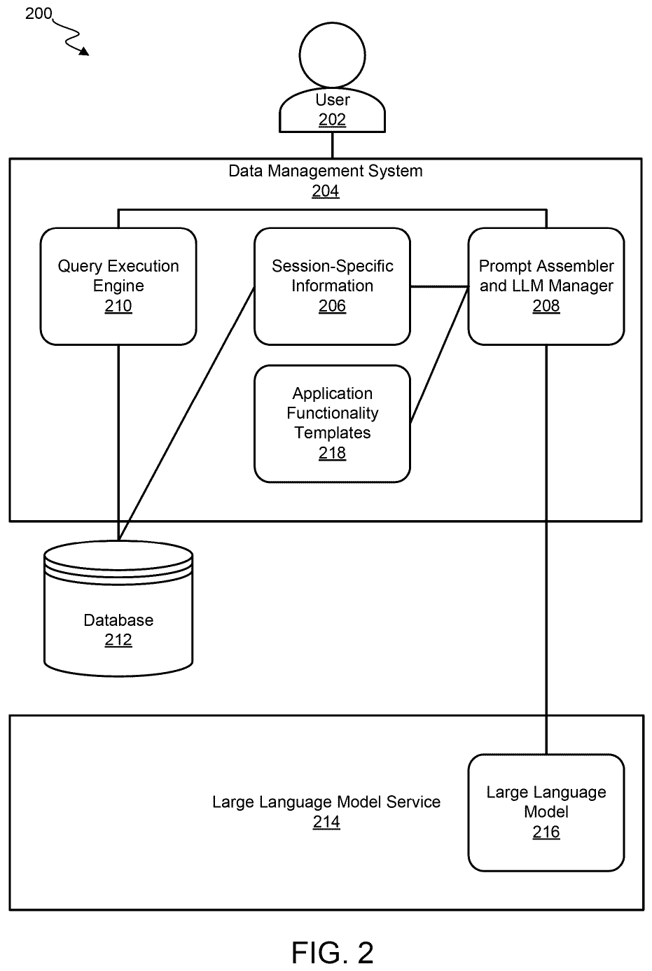

FIG. 2 illustrates a system diagram showing an example system for providing a context-specific prompt to answer a user query that takes into account session-specific information 206 and/or application functionality templates 218. As shown, user 202 submits a natural language request to data management system 204. Data management system 204 uses prompt assembler and LLM manager 208 to select session-specific information 206 and/or application functionality templates 218 to be included in a prompt. Prompt assembler and LLM manager 208 then prompts large language model 216 of large language model service 214. A result is received from the large language model 216 by data management system 204. In one example, the result includes data to be returned to the user via a user interface. In another example, the result includes a data structure to be executed by an application API to trigger application functionality that may result in data being displayed to the user. In another example, the result includes a data structure describing a query that is executed by query execution engine 210 against database 212 before data is returned to the user via the user interface.

In one embodiment, the method further includes retrieving the structured text representing the one or more items of data based at least in part on a REST call to access a data repository.

In the same or a different embodiment, the data structure conforming to the structured data return template triggers a REST call to access a data repository and retrieve one or more data values to perform one or more operations on the one or more data values.

In the same or a different embodiment, the data structure conforming to the structured data return template triggers a REST call to create one or more objects in a data repository and navigate to one or more user interfaces to analyze the one or more created objects.

### Accessing Data Via a User Interface

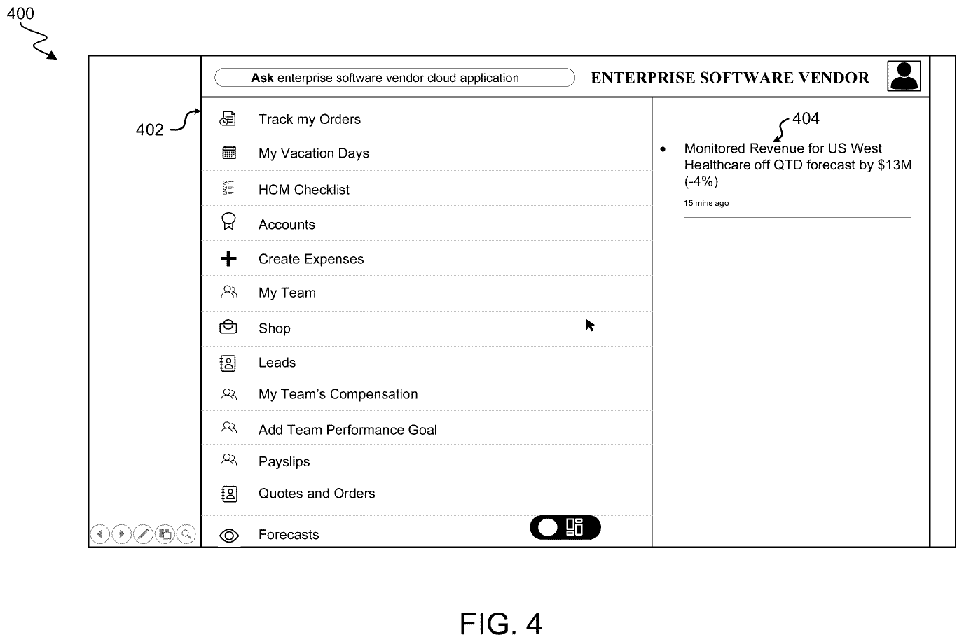

In one embodiment, an application platform may provide a user interface that allows a user to authenticate to the application platform or other system for accessing one or more applications that provide corresponding application functionality. In the example interface 400 shown in FIG. 4, the application platform may provide options 402 for tracking orders, reviewing vacation days, reviewing to-do items, reviewing accounts, creating expenses, reviewing or communicating with a team, adding resources or tools accessible from the application platform or accessible to the team, checking on leads, reviewing or modifying compensation, adjusting performance goals, reviewing pay slips, editing quotes and orders, or making forecasts.

The interface may include one or more notifications 404. For example, the notifications 404 may be triggered by anomalies detected by the system or by individual applications and reported up to the application platform. In the example shown, a notification is displayed from “15 minutes ago” indicating “Monitored Revenue for US West Healthcare off QTD forecast by $13M (−4%)” The notification may be selectable to navigate the user into a particular application for a particular purpose relating to the content of the notification. In the example, the notification may be selectable to cause navigation to a user interface for reviewing accounting information for US West Healthcare to better understand why the monitored revenue is off by $13M.

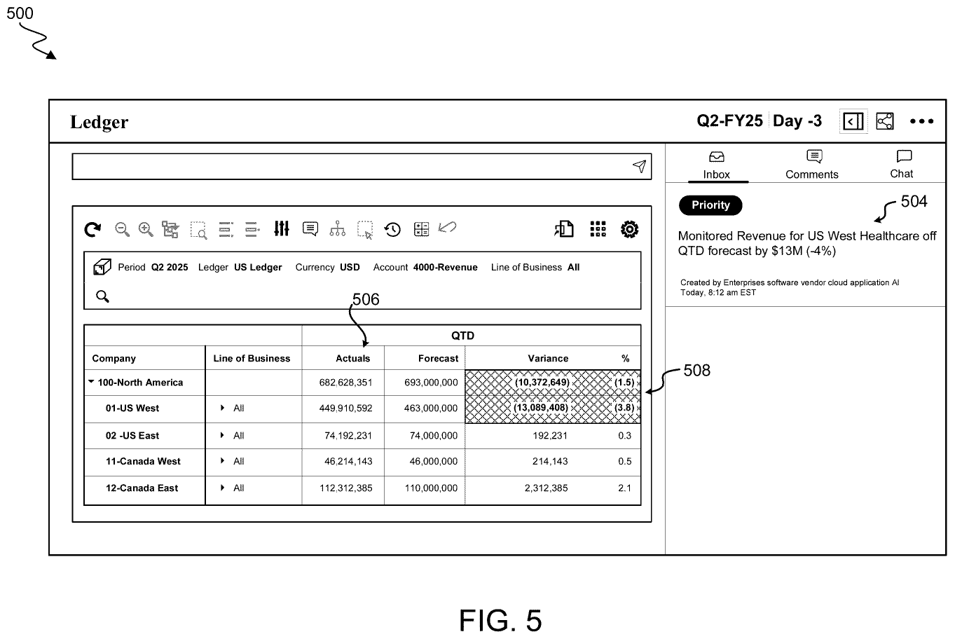

In one example, selection of the notification may navigate the user via the user interface to an example Ledger interface 500 depicted in FIG. 5 that shows a revenue 506 for “US West” and the revenue variance 508 and/or % that triggered the notification 504, which may be graphically distinguished as shown as an insight for the revenue. Other columns from which the notification values were triggered may also be displayed, such as the Company dimension (including “US West”), Line of Business (shown as “All” in FIG. 5), and the Actuals and Forecast numbers for the current quarter of the time dimension (“QTD”). In the example, the Variance that triggered the notification is determined based on the Actuals and Forecast numbers, indicating that the Actuals and Forecast numbers are relevant to show in the interface as a result of navigation based on the notification 504. The Ledger interface consumes the context of the alert, including the fields reported by the notification, to construct an interface with the relevant dimensions as a starting point for analyzing the notification. For example, the interface may show details for account balances that are reported high or low by the notification.

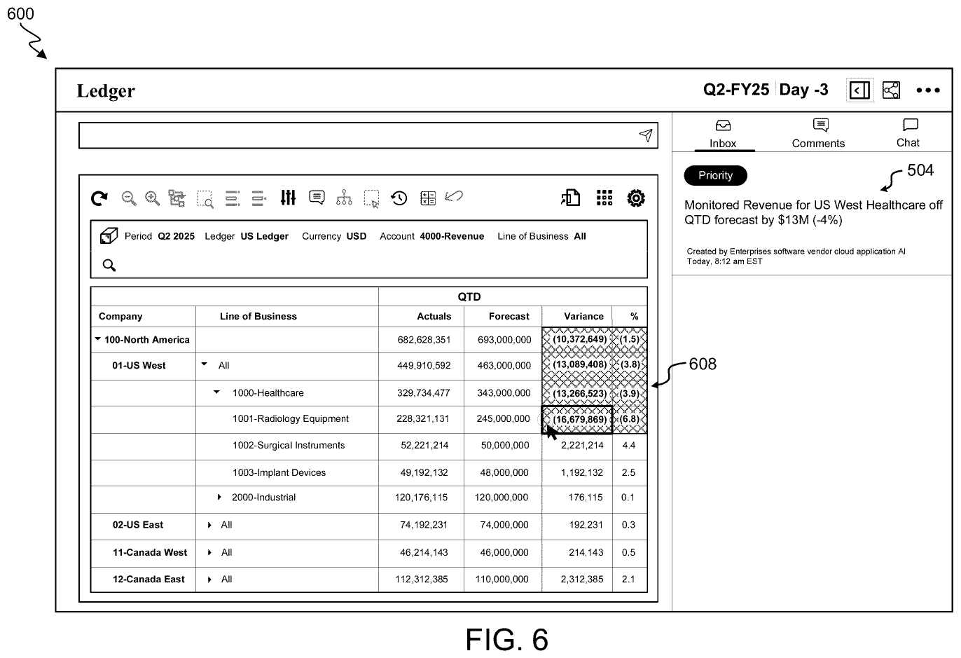

A data management system manages the data shown on the interface and interacts with an application query layer connected to a back-end database, to a date warehouse, or directly to a back-end database to provide data for display on the interface. As shown in FIG. 6, data displayed on the interface 600 may be selectable, such as by a cursor selecting data 608. In the example shown, the Lines of Business dimension has been drilled down to view different corresponding lines of business and individual revenue numbers for those lines of business. In the example interface 600 of FIG. 6, a cell showing a $16,679,869 variance in revenue from the “1001-Radiology Equipment” Line of Business has been selected on the user interface 600.

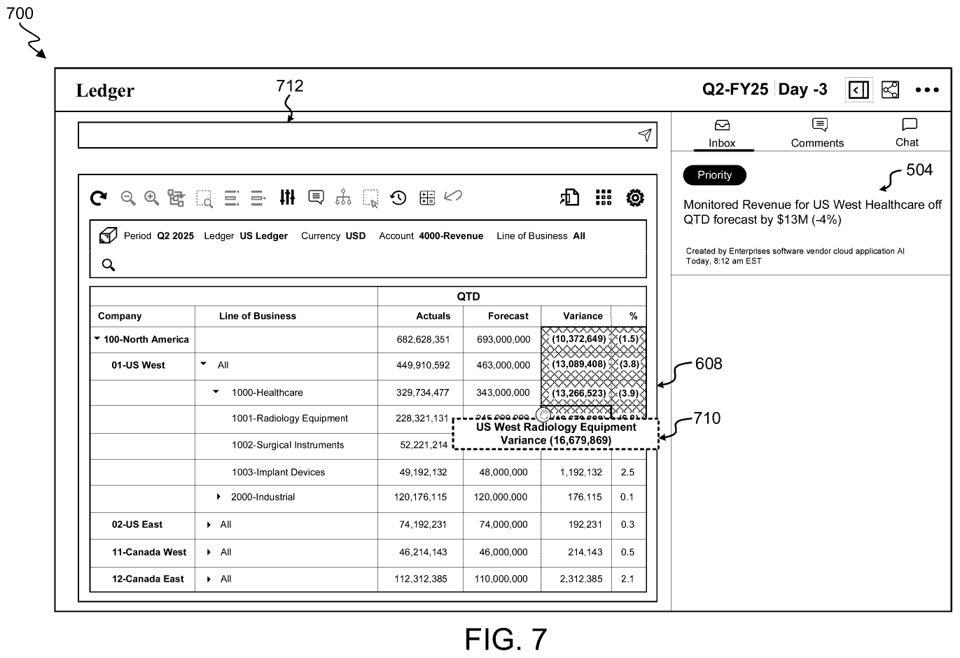

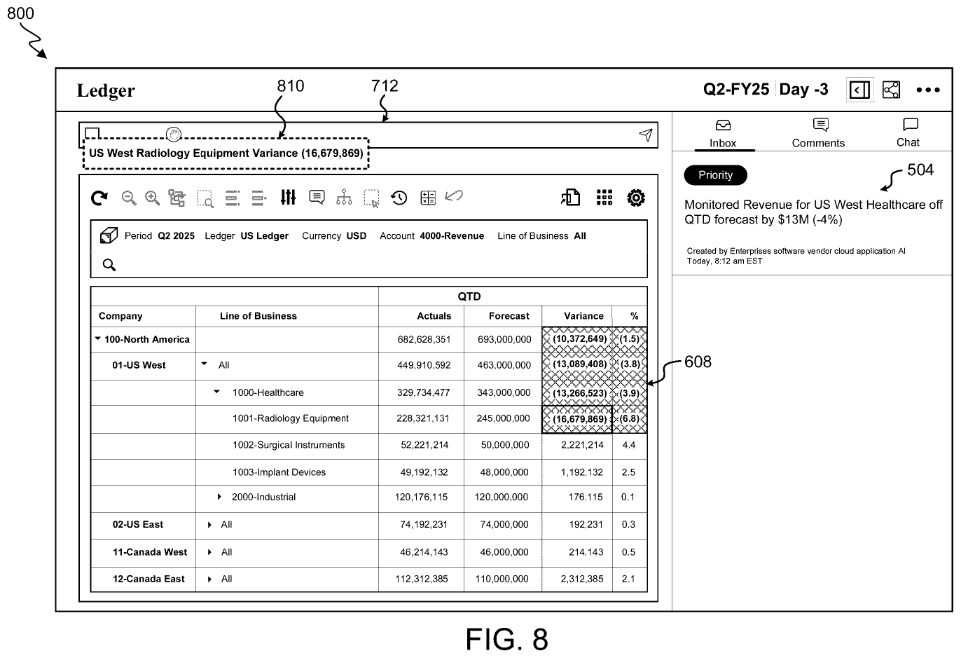

FIG. 7 shows that selection of the cell from data 608 may be extended to drag the cell across the user interface 700 to text input region 712. As the cell begins to be dragged, a selected information summary box 710 or other graphical element associated with the selected data may be displayed next to the cursor indicating the value being dragged across the interface even as the cursor moves away from the originally selected data item(s). The selected information summary box 710 may list, aggregate, or summarize the selected value(s) and corresponding field(s) being dragged across the interface to improve useability and avoid unnecessarily returning to a data selection state of FIG. 6 when the correct data has been selected. As shown in interface 800 of FIG. 8, the selected information summary box 810 may be dragged to a text input region 712 or other input region of the user interface. Upon dropping the selected information summary box 810 into the input region 712, the selected summary box 810 or a graphical element associated with the selected data may be displayed as fixed in the input region 712. If the input region 712 receives text input, the graphical element may be colored differently or otherwise graphically distinguished from the surrounding input region to indicate that the dropped item is not text but is actually item(s) of data that will be used to evaluate other input to be provided.

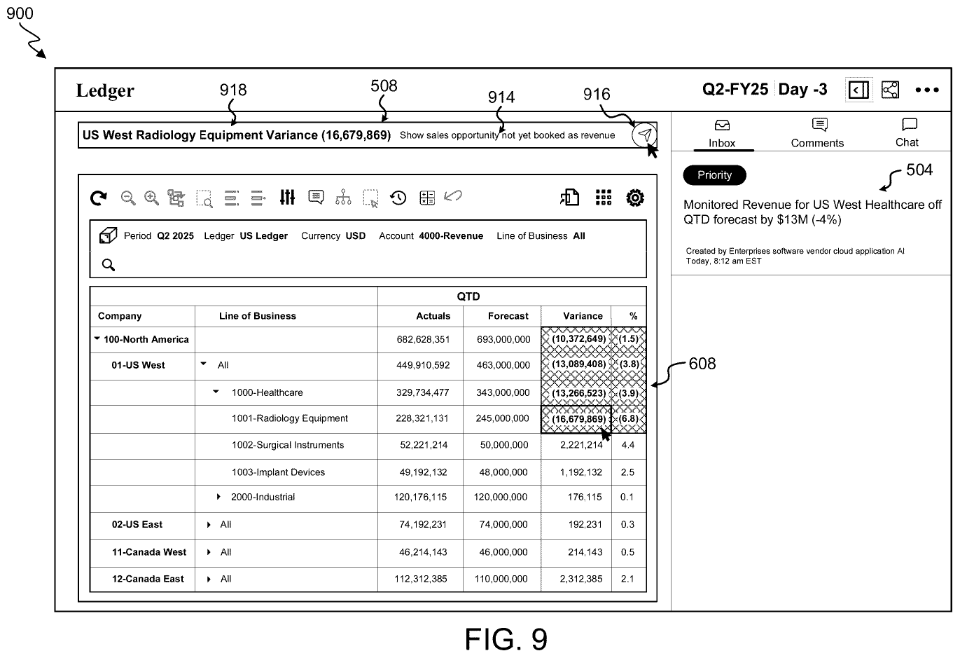

In the example interface 900 of FIG. 9, additional text 914 is typed in as a user request of “show sales opportunity not yet booked as revenue.” The user request 914 may be transmitted to the data management system via the send button 916, shown under the cursor in the example of FIG. 9, and context 918 corresponding to the selected data may be included in a prompt to a large language model (LLM). For example, the underlying values of the data, the dimensional hierarchy where the data is located, any notifications or anomalies detected involving the data, and any surrounding or related data values, for example, from sibling members of a dimension or other historical data points for the same member may be included in a prompt to the LLM to respond to the user request. By selecting relevant values to include in the prompt, the data management system promotes a complete response to the user request without additional drill-down or roll-up requests required after the response has been provided and consumed by the application.

In this example, the user is selecting to include the values themselves in the user request either by dragging the values to the text input region of the user request or by selecting the values on the screen. This user interface feature promotes visibility to the user that information selected is being passed into the large language model via a prompt, contributing to data security. In one example, data structure but not data values are sent to the LLM without an explicit user interface action indicating that the values should be sent to the LLM, such as by dragging the values to the user request region or by having the values selected when the user request is submitted.

In one embodiment, the LLM may use the relevant data to draw conclusions and make recommendations in response to the user request, and to trigger application functionality responsive to the user request. For example, the LLM may return a data structure that causes the application to display information relevant to both the selected data values, conclusions that may be drawn therefrom, and the natural language from the user request.

In another embodiment, rather than including the selected data in the prompt to the large language model, the data management system includes schema or data structure information about the selected data, using the selected data as a guide for what schema should be included or not, without providing the values of the selected data. The prompt may request the LLM to generate a query that answers the question, and the LLM may respond with a query that looks up certain values based on the provided schema or structure information. The values may then be retrieved based on the response and used to cause display of information responsive to the user request. The displayed information responsive to the user request may include retrieved values as well as natural language output form the LLM explaining what operation is being performed.

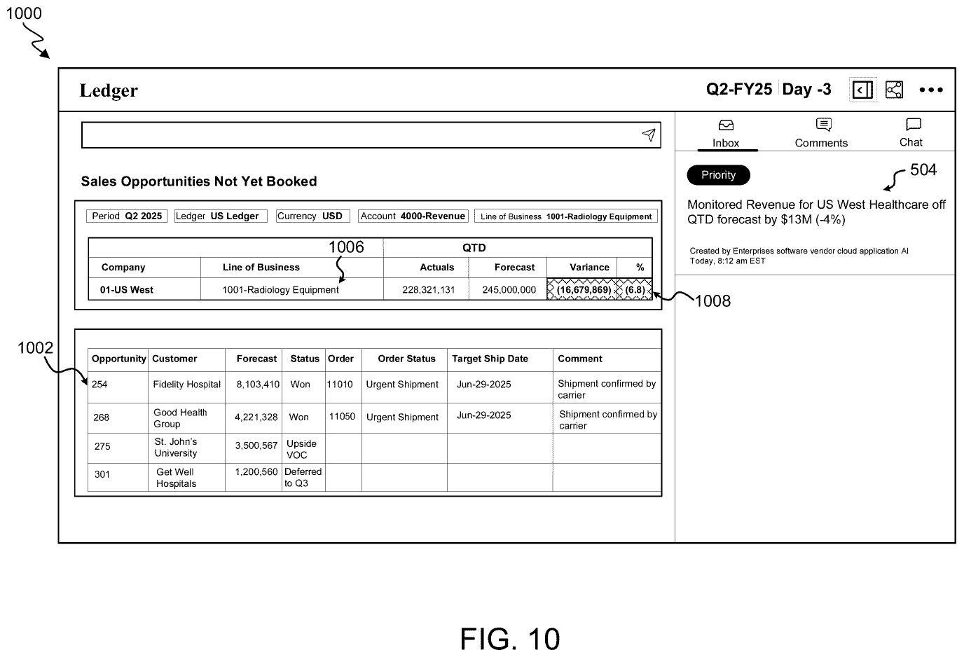

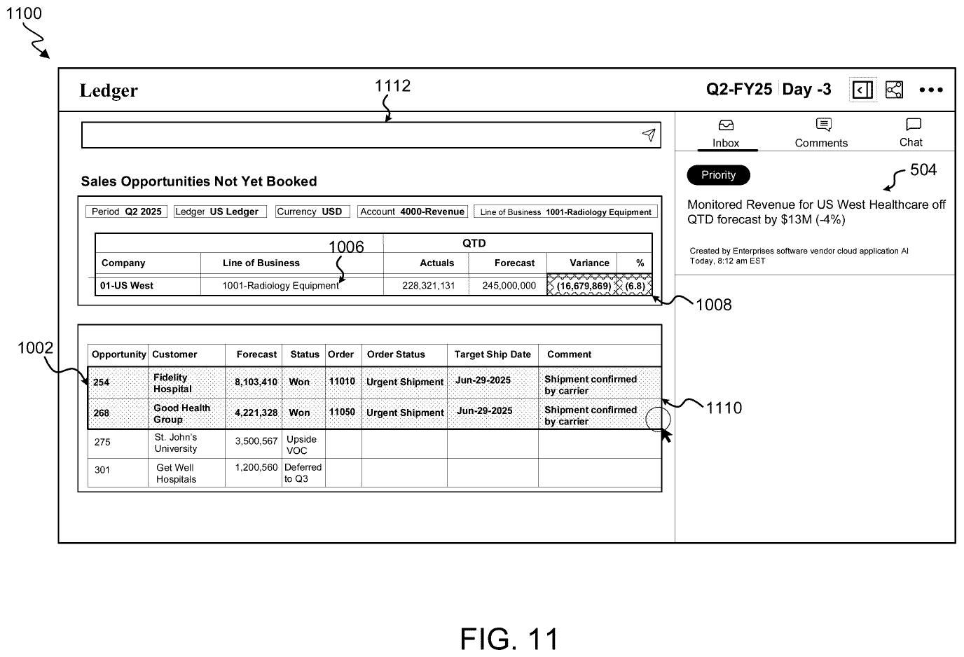

Regardless of whether the LLM uses data values directly (earlier pulled in by the data management system) or uses data structure to infer which data queries should be run to pull in relevant data values (later pulled in by the data management system), a user interface showing relevant data values, visualizations, prepared or partially completed tasks may be shown in response to the user query based on a response from the LLM. For example, FIG. 10 shows an example interface 1000 showing sales opportunities not yet booked 1002 for the line of business selected 1006, which may impact how much revenue has been collected for that line of business in the quarter-to-date and is responsive to the user request from FIG. 9. Summary information may be shown for the line of business selected 1006, including an anomalous value 1008 that led to the further analysis in interface 1000. As shown, opportunities 1002 are listed along with forecasted revenue amounts for each of the opportunities, a status, and a target ship date. In the example, a further selection may be made for one or more of the rows, columns, or cells of data, such as the two rows 1110 shown as selected in FIG. 11. In the accounting example shown, a user may select rows 1110 that represent opportunities that should be accrued before a close of the financial period. Upon selection of the two opportunities 1110 with corresponding forecasted amounts showing a status of “won” and comment “shipment confirmed by carrier,” the data management system may separately track data that is in view and data that has been actively selected in the user session, whether or not the data has been dragged to the text input region 1112.

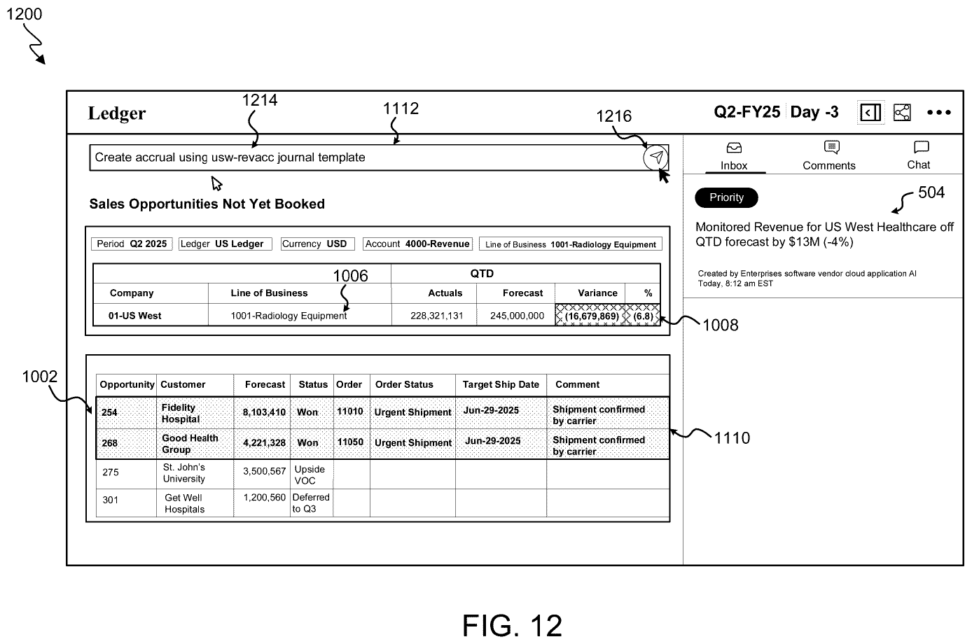

This information about data shown and/or data selected may be provided as context in a prompt to a large language model to perform application functionality. In the example of FIG. 12, a user request 1214 is typed into a text input region 1112 as “Create accrual using usw-revacc journal template.” In the example, the instruction is to perform a data transaction against a database by creating a journal entry. Upon submission of the request using submit option 1216, the data management system may include schema information about the selected rows 1110 and/or actual values of fields in the selected rows 1110 to the large language model so that the large language model may perform the requested application functionality.

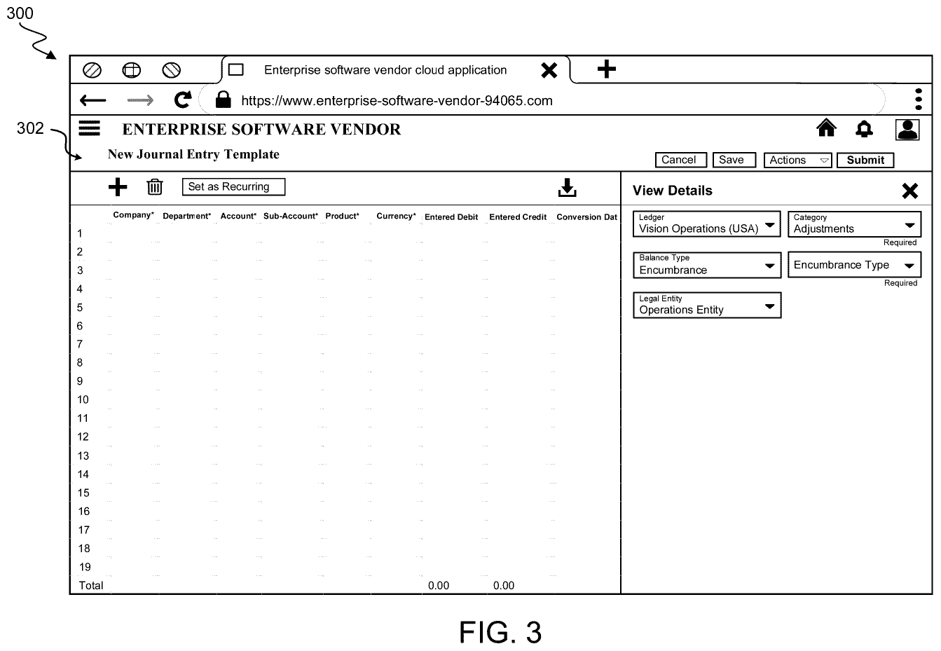

In this example, the user request 1214 also makes reference to a specific application-side template of “usw-revacc journal template.” The application may detect a semantic similarity, exact match, or partial match between an existing template name or stored description and content of the user request and additionally or alternatively include, in the prompt, a structure of the template to use for creating the journal entry. FIG. 3 shows an interface 300 showing an example new journal entry template 302, the structure of which may be included in a prompt to the LLM. The structure may be consumed by the large language model to return a resulting structure that is compatible with an application-exposed API that uses the template to create a journal entry, as constraints of the application-exposed API or corresponding data structure to trigger the API may be provided in the prompt to the LLM.

In the example, the large language model may process the prompt and return a data structure, such as a JSON data structure including embedded values and/or commands consumable to interact with an API of the application, that causes the application to generate a journal template using a certain type of journal template and by passing in certain values from the selected data to the journal template.

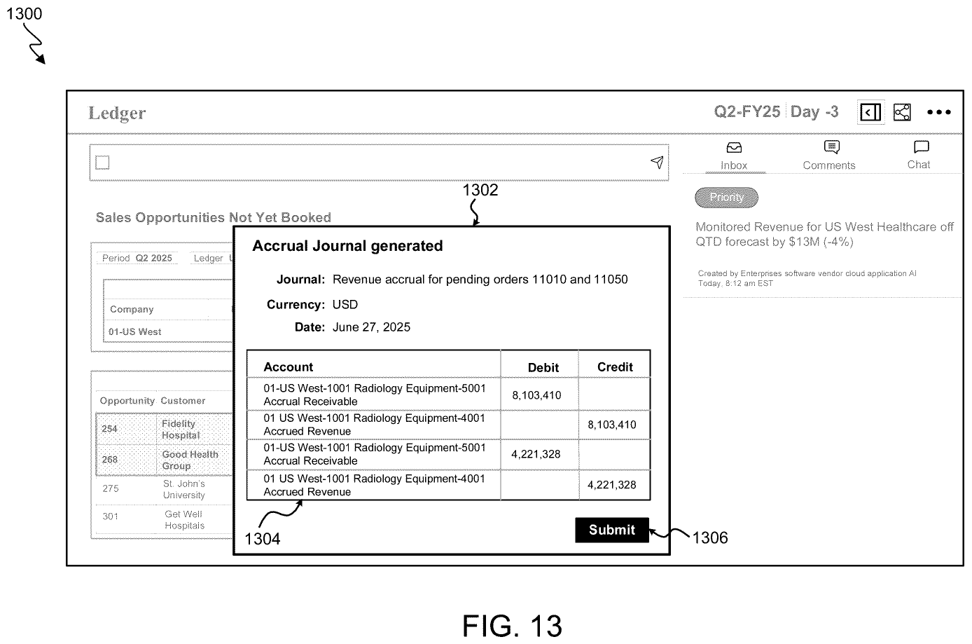

In the example of FIG. 13, an interface 1300 is shown where the data management system has caused, based on a response from the large language model, an accrual journal 1302 to be generated. As shown, the journal 1302 has a title determined by the large language model based on the input data, as “Revenue accrual for pending orders 11010 and 11050,” with certain defaults that may be specified in the prompt template or inferred by the LLM. The items are selected for inclusion in the journal template as accrual receivables that have not yet occurred as recognized against accrual revenue that is being recognized for the quarter.

As shown in FIG. 13, the Account line items 1304 have been populated based on additional details made available from the user session, such as the Company name included at the beginning of the Account name, followed by the Line of Business, followed by an accounting code (5001 for Accrual Receivable and 4001 for Accrued Revenue) and type of entry. The debit or credit corresponding to the type is listed based on the forecast amount. The prompt template may include default assumptions, naming conventions, or other formats that should be used, or, in the absence of such information, the LLM may determine tenant-generic naming conventions to use in the response. The journal 1302 may be created upon selection of the submit option 1306.

### Receiving a Selection of Data Relevant to a User Request

In one embodiment, data relevant to the user request may be selected, viewed, or previously visited in a user session for which the user request is submitted. The relevant data values and/or structural dimensional intersections identifying where the relevant data values belong in a multidimensional database may be included in a prompt that requests results based at least in part on the user request. This additional information about the structure and/or values of the underlying data viewed, interacted with, or even explicitly dragged to the user request input region may help the LLM to generate a response that addresses particular values and patterns in the selected data.

In one embodiment, item(s) of data are selected by being highlighted in the user session as the user request is submitted as text input. Information about the selected item(s) of data may be included in the prompt.

In another embodiment, item(s) of data are selected by being dragged into an input field. The data management system may cause display, in the input field, of a graphical object representing the item(s) of data, the graphical object indicating that information about the item(s) of data are included with the user request upon submission. For example, the item(s) may be named in a box, oval, or other graphic. The data management system may further receive the user request as text added to the input field, for example, adjacent to the graphical object.

### Determining the User Request is for a Particular Item of Application Functionality

In one embodiment, application functionality templates may be stored to trigger certain types of application functionality. The application functionality template may include names or aliases of the application functionality, descriptions, keywords, or other details that may be matched with user requests, for example, via semantic similarity based on a distance between a vector embedding of the information about the application functionality template and a vector embedding of the user request. As another example, the application functionality template may be located by prompting a large language model with a specified set of available application functionality templates and descriptions or definitions of the application functionality templates, along with a request to identify which application functionality template(s) are most associated with the user request. Corresponding structures usable to trigger any identified application functionality templates may then be attached to another prompt along with the user request to query the large language model to produce a resulting data structure conformant to the application functionality template that was selected. The data management system may consume the resulting data structure to trigger application functionality pursuant to the user request as determined by the LLM.

In various embodiments, the application functionality template or other structured data return template is stored separately from the prompt template. The prompt template may support different structured data return templates that are selectable depending on the user request.

In the same or a different embodiment, the data management system determines that the structured data return template is relevant to the user request based at least in part on a semantic similarity of the user request to a content embedding stored for matching the structured data return template to user requests. For example, the semantic similarity may be based on Cosine Distance, Euclidean Distance, Pearson Correlation Coefficient, Manhattan Distance, Minkowski Distance, Hamming Distance, Chebyshev Distance, Jaccard Distance, Haversine Distance, and/or Sorensen-Dice Distance.

In one embodiment, instead of or in addition to determining a relevant structured data return template based on semantic similarity, the data management system determines that the structured data return template is relevant to the user request based at least in part on another prompt to the large language model. For example, the other prompt may ask which of a specified set of different items of application functionality the user request is attempting to trigger.

### Prompting a Large Language Model

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, Llama 3, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data available in a user session with an application. The data schema may include dimension names (e.g., Scenario, Market, Year, Product, and Measures), member names, and drill-down and roll-up hierarchies that are available to view or manipulate in the user session. The data schema may be formatted in a hierarchical format, such as JSON, XML, or another structured and delimited format that distinguishes between members at different levels of the hierarchy.

The prompts may also specify a format for providing the reply, through example valid responses to example requests, and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any. If the LLM reply includes a data structure consumable by the application, the validation may include verifying that the data structure conforms to a schema or set of structured instructions exposed by the application through an API.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as “{” and “}” or “[” and “]” in the response. The consumable JSON object may be separated from a remainder of the response for consumption by the application to create an executable structure to trigger application functionality.

### Consuming a Data Structure Generated by the Large Language Model to Trigger Responsive Actions

In one embodiment, the data structure conforming to the structured data return template triggers creation of one or more objects in a data repository and causes an option to be displayed for confirming the one or more objects.

Various other responsive actions may be exposed by an application API and triggered by a data structure returned by the LLM. For example, the data structure may be consumed to trigger API functionality by an agent that is designed to call the application API based on structured forms of commands. Different parameters to pass into the API may be identified in different structured positions in the data structure. In another example, the data structure itself, such as a JSON or XML-based data structure, may be passed directly into the application to trigger corresponding functionality.

The functionality may include, for example, displaying information corresponding to selected dimensions and/or filters that may be passed in as parameters, displaying reports with certain variable parameters passed in, creating objects with certain variable parameters passed in, creating objects according to a named template with certain variable parameters passed in, displaying a visualization corresponding to selected dimensions and/or filters that may be passed in as parameters, triggering a notification based on certain variable parameters passed in, changing a status of an object or otherwise modifying values of an object based on certain parameters passed in, etc. The parameters to be passed into the application may be determined based on default parameters and/or parameters that are provided by the LLM in the data structure returned. For example, the data structure for a corresponding item of application functionality may have designated positions to provide the corresponding parameters, and the LLM may fill in the corresponding parameters in the designated positions.

In various embodiments, the LLM may be given, in the prompt, examples of valid invocations of the application functionality template when the application functionality template is determined to be relevant to a user request. The valid examples may be provided along with the data structure specifications for triggering the application functionality.

### Multi-Agent Architecture for Enriching Application Functionality and/or Data Insights

In various embodiments, various functional components of the data management system may be performed by different agents with access to different tools and/or with access to large language model(s) for performing separate tasks. Each agent may have access to different tools and/or different retrieval augmented generation (RAG) data stores or data sets, and access to the different tools may be managed by different authentication data accessible to the different agents. For example, a first agent may use a first authentication key to access an API of a first tool for the purpose of performing or supporting a first set of application functionality for a first type of data, and a second agent may use a same or different authentication key to access a same or different API of a same or different tool for the purpose of performing or supporting a second set of application functionality for a second type of data. Any number of worker agents may work together or separately to handle same or different types of data, use same or different tools, interact with same or different LLMs, and use same or different steps or sub-steps before prompting the LLM, same or different steps or sub-steps after prompting the LLM, use same or different data transformations, and have other functional similarities or differences between each other. The agents may communicate using an agent-to-agent protocol and may report to the supervisor agent for assembling content and presenting the assembled content to the user in response to a user request.

In various examples, insight detection may be performed by a separate agent using separate tools than an agent that performs insight visualization, and/or certain types of insights, such as anomalies or predictions, may be detected or visualized by agents that are specialized to handle the corresponding type of insight.

In one embodiment, the ledger agent supervises a plurality of other agents or assistants to enrich application functionality and/or provide data insights in particular scenarios determined by the ledger agent. In the same or a different embodiment, the ledger agent supervises a plurality of supervisor agents, and each supervisor agent supervises one or more worker agents. The supervisor agents may include, for example, a ledger insights monitor, a ledger operational readiness assistant, and/or a ledger forecasting, prediction, and analysis readiness assistant.

In one example, the ledger insights monitor supervisor agent is responsible for tracking criteria that govern insights and supervises a ledger insights tracker worker agent and/or an insights explorer worker agent. The ledger insights tracker worker agent may use tools and/or unique steps to monitor insights criteria and generate insights and alerts.

Monitoring insights criteria may include capturing criteria for monitoring through a user uploading a document or monitoring request in a natural language (and converting such a request into a deterministic set of criteria), or a system detecting data and conditions to use for monitoring behind-the-scenes. Generating insights and alerts may include execution of the monitoring criteria to determine if any insights are detected when the criteria is met.

The insights explorer worker agent may use tools and/or unique steps to generate view(s) or other data visualization(s) showing data sets with different granularity, organization, and/or emphasis, such as a period activity view, a drill-down view, a side-by-side comparison view, and/or an explainability view. For example, a period activity view may show, for a general ledger balance, what happened as an aggregate level of activities that contributed to the balance. The activity may come from upstream business processes, and a drill-down view may show contributing transactions to the activity. A side-by-side comparison view may show how the activity has trended compared to a prior quarter, prior year, etc. An explainability view may show how different factors contributed to a variance in data over time. In a particular example, an insight is generated to indicate a revenue has exceeded a certain amount or threshold. In this example, the insight may be generated by the ledger insights tracker worker agent, and the insight may be passed to an insights explorer worker agent to generate a view of the insight for display in an interface. The insights explorer may generate different views compatible with different insights based on what information users often prefer to see, as well as heuristics and customized settings, for different types of insights. For example, the insights explorer may generate a period activity view that shows period activity amounts and balances.

In one example, the ledger operational readiness assistant supervisor agent supervises a ledger anomalies tracker, a suspense accounts analyzer, an intercompany mismatch analyzer, a clearing accounts analyzer, a reconciliation monitor, and/or a period balance variance assessor.

The ledger anomalies tracker worker agent may use tools and/or unique steps to detect duplicate journals, detect high value journals, detect unusual account activity, and/or detect back-dated journal entries. Detecting duplicate journals may include detecting journals that have similar accounts, amounts, values, times, etc., but exist separately and may be mistakenly duplicated. Detecting high value journals may include detecting journal entries above a threshold (e.g., $5,000 or $50,000, or higher or lower depending on the organization) as high value journals. Detecting unusual account activity may include detecting activity that is uncommon for certain accounts, such as booking a liability in a revenue account or booking revenue in an asset account. Detecting back-dated journal entries may include detecting journal entries that are created but relevant to a date too far in the past, such as a date far enough in the past that triggers a warning flag or additional review and approval.

The suspense accounts analyzer worker agent may use tools and/or unique steps to assess suspense account balances and/or inspect suspense account activity. Assessing suspense account balances may include using a suspense account as a temporary catch-all account to progress transactions that cannot otherwise be accounted properly, to avoid transaction failure. The suspense accounts may have time limits before the suspense accounts are to be resolved and reclassified. Inspecting suspense account may include determining which transactions are contributing to a suspense account that has reached limits and reclassifying the transactions to appropriate non-suspense accounts.

The intercompany mismatch analyzer worker agent may use tools and/or unique steps to inspect intercompany account open balances, co-relate intercompany AR/AP transactions, and/or investigate intercompany account activity. Inspecting intercompany account open balances may include analyzing balances or open positions between two organizations to ensure the balance view from the provider side matches or approaches matching the balance view from the receiver side such that the balances are synchronized. Co-relating intercompany AR/AP transactions may include matching or promoting a match between accounts receivable transactions and a corresponding accounts payable transaction, and determining a reason (transaction on hold, etc.) why an accounts receivable transaction does not match an accounts payable transaction.

The clearing accounts analyzer worker agent may use tools and/or unique steps to assess clearing account balances, and/or inspect clearing account activity. Assessing the clearing account balances, which are balances of temporary accounts that should have zero balance, includes analyzing why the clearing accounts have a balance (e.g., downstream activity has not yet occurred) and whether the clearing account has held a balance beyond a threshold time.

The reconciliation monitor worker agent analyzes transactions captured in subledgers, such as payables, receivables, fixed assets, cash management, or other captured external transactions and compares the aggregate value of these transactions to balance in the general ledger where these transactions have been pushed. The reconciliation monitor worker agent may use tools and/or unique steps to track account to supporting transaction sources, co-relate supporting transaction balances, assess external transaction details, assess payables transaction details, assess receivables subledger details, assess fixed assets subledger details, assess cash management subledger details, assess other subledger supporting details, and/or analyze or explain reconciliation differences. Tracking account to supporting transaction sources includes breaking down the balance of the general ledger based on the different sources of the balance (e.g., payables, receipt accounting, coupon system, etc.). For each source, co-relating supporting transaction balances includes surfacing the transactions that are contributing to the activity for a given period and the given source. Assessing external transactions details, payables transaction details, receivables subledger details, fixed assets subledger details, and/or cash management subledger details includes analyzing aggregate information or valuation from a corresponding subledger, optionally using a subledger-specific process, and performing matching based on the aggregation. Analyzing other subledger supporting details includes determining that there are transactions that are unaccounted for or rejected and explaining these other details. Analyzing and explaining reconciliation differences may include explaining differences between a given subledger and the general ledger as a result of reconciliation.

The period balance variance assessor worker agent may use tools and/or unique steps to provide a period balance variance tracker and/or a budget balance variance tracker. The period balance variance tracker analyzes fluctuations in balances over a period in comparison with predicted amounts or amounts of a same period in a previous year to lead to certain insights. The budget balance variance tracker analyzes fluctuations in budgets over a period in comparison with predicted budgets or budgets of a same period in a previous year to lead to certain insights.

In one example, the ledger forecast, prediction and analysis readiness assistant supervisor agent supervises an allocation analyzer, a foreign exchange (FX) analyzer, a forecast variance analyzer, and/or an accruals monitor.

The allocation analyzer worker agent may use tools and/or unique steps to assess unallocated pools supporting details, assess balances for re-allocation considerations, and/or accept allocation criteria and generate allocations. An allocation is a pool of accounts that are allocated to other target accounts. For example, a building has electricity, rent, and janitorial services that may be pooled together and allocated to cost centers operating in the building. The expenses for the building get allocated to each of the cost centers in the building so that all of the building expenses are allocated. If any expenses remain unallocated from a pool, the allocation analyzer worker agent may flag the unallocated expense. Assessing balances for re-allocation considerations include detecting new activities. For example, allocations are typically scheduled to run in a frequency, but there can be new activities that happen after the schedule has run that may get factored in immediately. Accepting allocation criteria and generating allocations includes detecting and recommending allocation opportunities.

The FX analyzer worker agent may assess reevaluation of provisional impacts that may be impacted by exchange rates, for example. Revaluation includes analyzing foreign currency exposure of assets and liabilities denominated in foreign currency, such that the current or changed exchange rates are used to determine changes in exposure.

The forecast variance analyzer may track actuals to forecast variances, assess unaccounted, suspense, and/or supporting transactions, and/or co-relate forecast impacts and timing. Tracking actuals to forecast variances includes determining a difference between actuals that happened or are happening in comparison with a forecasted amount. Assessing unaccounted, suspense, and/or supporting transactions includes explaining gaps or variances between actuals and forecasts in terms of missing transactions or changes in amounts. Co-relating forecast impacts and timing includes making a recommendation of whether to wait to resolve the missing or incomplete transactions or whether an accrual is needed for issues that will not be resolved in time before an end of a reporting period.

The accruals monitor worker agent may generate accrual true-up journals and/or track accrual journals and related supporting transactions. In one example, a ledger forecast, prediction, and analysis readiness assistant supervisor agent uses information about selected items to cause an accruals monitor agent to generate an accrual journal entry that may be rendered in an interface for a user to accept or reject the accrual journal entry. In another example, a forecast variance analyzer worker agent may forecast a variance between actual revenue and forecasted revenue for a set of data identified to the forecast variance analyzer by the ledger forecast, prediction and analysis readiness assistant supervisor agent.

### Example Prompt Template and Dynamic Value Retrieval Logic

An example prompt template and dynamic value retrieval logic is shown with optional sections of domain knowledge included for additional context when relevant and dynamic sections that may include values filled in based on environment variables and other context when available and relevant. The sections are underlined herein to distinguish the sections from each other, and any sections may be included in a prompt template and/or used for reference to generate the prompt template. The example below includes logic for obtaining dynamic values that may be substituted into the prompt template, even if the logic itself is not included in the prompt once the values have been obtained.

### User Query: Show Trade Revenue by LOB QoQ

### Financial Domain Knowledge <Static>

### Details

Question about financials typically involve different entities such as a Legal Entities, Business Units, Chart of Accounts, Calendar, Currencies,
Ledgers which are used to segregate financial data.
Each key piece entities have alternate representations or aliases. The alternate names or conventions are listed below.
   Legal Entity
      Alternate names: {Company, Corporation, Enterprise, LE, First Party}
   Business Unit
      Alternate names: {Organization, Operating Unit, Department, Division, Org, OU, BU}
   Business Function
      Alternate names: {Business Process, Operational Area, Departmental Activity, Organizational Role, Functional Area, Operational Function, Core Process, Service Line}
   Client BU
      Alternate names: {Customer BU, Client Unit, Client Function}
   Service Provider BU
      Alternate names: {Shared Service Center, Service Division, Support Services BU, Service Operations BU, Operational Support BU, Client Services Unit}
   Chart of Accounts
      Alternate names: {Account structures, Accounting Flexfield Structure, CoA}
   Calendar
      Alternate names: {Accounting calendar, Fiscal Calendar, Business Calendar, Financial Calendar, Ledger Calendar, General Ledger calendar or GL Calendar}
      Related Contexts: {Commitment Calendar, Budgetary Control Calendar, Budgetary Calendar, Projects Calendar}
   Period
      Alternate names: {Accounting Period, Transaction Period, Current Period, Reporting Period}
   Currency
      Alternate names: {Base Currency, Functional Currency, Ledger Currency}
      Related Contexts: {Foreign Currency, Entered Currency, Transaction Currency, Revaluation Currency}
   Currency Conversion
      Alternate names: {Conversion Rates, FX Conversion, FX Rates}
   Ledger
      Alternate names: {Financial Ledger, Set of Books, Primary Ledger, Corporate Ledger}
      Related Contexts: {Secondary Ledger, Reporting Ledger, Reporting Currency, ALC, Alternate Ledger Currency}
   Account
      Alternate names: {Natural Account, Asset Account, Liability Account, Revenue Account, Expense Account, Equity Account, Retained Earnings Account}
   Intercompany Organization
      Alternate names: {Intecompany Entities, Intercompany Business Units, Intercompany Subsidiaries, Related Entities}
   Asset Book
      Alternate names: {Fixed Asset Ledger, Asset Ledger, Depreciation Book, Corporate Book, Tax Book}
   Account Qualifiers
      Alternate names: {Natural Account Segment, Balancing Segment or Company Segment or Entity Segment, Cost Center
      Segment or Department, Intercompany Segment, Secondary Tracking}
In financials contexts terms like YoY (Year over Year) etc. are used to compare financial data or performance between the one period and another period to identify trends, growth rates, and changes in metrics on a period basis. Some of the common comparison trends are as follows:
Time period Comparisons

```
  “time_period_comparisons”: [
    {
      “term”: “Day over Day”,
      “abbreviation”: “DoD”,
      “description”: “Compares data between the current day and the previous day.”
    },
    {
      “term”: “Week over Week”,
      “abbreviation”: “WoW”,
      “description”: “Measures performance between the current week and the previous week.”
    },
    {
      “term”: “Quarter over Quarter”,
      “abbreviation”: “QoQ”,
      “description”: “Assesses financial metrics between the current quarter and the previous
quarter.”
    },
    {
      “term”: “Year over Year”,
      “abbreviation”: “YoY”,
      “description”: “Evaluates data between the current year and the previous year.”
    },
    {
      “term”: “Month over Month”,
      “abbreviation”: “MoM”,
      “description”: “Examines changes between the current month and the preceding month.”
    },
    {
      “term”: “Rolling X over X”,
      “abbreviation”: “RxoX”,
      “description”: “Compares data over a rolling window of a specified period, such as rolling 12
months over the previous 12 months.”
    },
    {
      “term”: “Half-Year over Half-Year”,
      “abbreviation”: “HyYoY”,
      “description”: “Compares the first half of the current year to the first half of the previous
year, and similarly for the second halves.”
    },
    {
      “term”: “Trailing Twelve Month”,
      “abbreviation”: “TTM”,
      “description”: “Compares the last twelve month of data.”
    },
    {
      “term”: “Year To Date”,
      “abbreviation”: “YTD”,
      “description”: “Compare data from the start of the current year to the present day”
    },
  {
    “term”: “Fiscal Year-To-Date”,
    “abbreviation”: “FYTD”,
    “description”: “Compare data from the start of the fiscal year to the present day”
  }
  ]
}
```

### General Ledger Domain Knowledge <Static>

Ledger Set
   Alternate names: {Ledger Group, Multi-Ledger, Financial Ledger Set, Accounting Ledger Set}
Data Access Set
   Alternate names: {DAS, Access Set, Access Set Definition, Data Access Profile, Access Group}
Financial Category
   Alternate names: {Financial Group, Account Category, Financial Classification, Financial Type, Financial Segment}
Chart of Accounts Dimensions
   Asset, Liability, Revenue, Expense and Owner's Equity maps to segment in Chart of Accounts with label/qualifier—GL_ACCOUNT
   Company, Entity, Balancing Segment Value, Primary Balancing Segment Value, BSV, PBSV maps to segment in Chart of Accounts with label/qualifier-GL_BALANCING
   Department, Cost Center, LOB maps to segment in Chart of Accounts with label/qualifier—FA_COST_CTR
   Revaluation tracking, Secondary segment, secondary balancing segment maps to segment in Chart of Accounts with label/qualifier—GL_SECONDARY_TRACKING
   Intercompany Accounting, Intercompany Transactions, Intercompany settlements, Intercompany transfers maps to segment in Chart of Accounts with label/qualifier—GL INTERCOMPANY

### General Ledger Balances Domain Knowledge <Static>

The General Ledger Balances Analytic View details:
   Balances AV references financial balances from the gl_balances fact table in a multidimensional analytic view for real time, interactive financial inquiry reporting and analysis.
   Is uniquely identified by a combination of the chart of accounts and accounting calendar.
   Consists of a set of defining business entities called Dimensions, hierarchies and Measures.
   Dimensions define how data is categorized, and each dimension can define one or more hierarchies that represent levels of granularity
   Balances AV contains two types of dimensions-Standard and Chart of Accounts Dimension
      Standard Dimensions include
         Accounting Period: Represents time frame, such as months, quarters, or years.
         Ledger: A collection of financial accounts for an entity, such as corporate or regional ledgers.
         Currency: Represents currency such as USD, EUR, etc.
         Currency Type: Specifies how currency is managed, such as Functional, Reporting, or Transactional Currency.
      Chart of Accounts Dimensions:
         There exists one dimension corresponding to each COA segment AV is based on
         Each COA segment dimension can have one or more hierarchies defined
   Balances AV includes below measures that represents aggregated balances

GL Balances AV Measures

```
[
  {
    “measure”: “beginBalance”,
    “description”: “Beginning period balance”
  },
  {
    “measure”: “periodNetBalance”,
    “description”: “Period net balance”
  },
  {
    “measure”: “endingBalance”,
    “description”: “Ending balance”
  },
  {
    “measure”: “endingBalanceQtdQr”,
    “description”: “Ending balance quarter to date”
  },
  {
    “measure”: “endingBalanceYtdYr”,
    “description”: “Ending balance year to date”
    }
  ]
```

Show results aggregated at Primary Balancing Segment Level
Show results in below sequence wherever possible
   1. <Ledger Information>,<Period Information>,<Currency Information>
   2. <Primary Balancing Segment>,<any other COA segment identified in user Input>
   3. <Measures>
      Derived/defaulted values from User Session <Dynamic>
User session language: [US]
Current Data Access set for the user is {Vision Foods-USA Ledger}
   Below context is derived from Data Access Set definition
      Accounting Calendar: Vision Foods US
      Accounting Calendar Id: 101234567806011
      Chart of Accounts: VF_USA_Accounting_Flexfield
      Chart of Accounts Id: 54604
Analytic view for current Data Access set is {glbalanceav}
   Logic to derive Current Access Set and Analytic View
a) Data Access set assigned to profile option ‘GL_CURRENT_ACCESS_SET_ID’ is termed current data access set, and it is derived using a rest end point.

### Example REST Call

http://{{host}}: {{port}}/api/boss/data/objects/XXXX/generalLedgerSetup/v1/profileOptionValueList? $filter=“levelName=‘USER’ AND
level Value=‘XXXXXXXXXXXXXXXXXXXXXX’ AND
profileOptions[profileOptionName=‘GL_CURRENT_ACCESS_SET_ID’]” &$fields=profileOptionValue

### Example Response:

```
{
  “items”: [
    {
      “profileOptionValue”: “500”,
      “$id”: “1,101,500,USER,XXXXXXXXXXXXXXXXXXXXXXXXX”
    }
  ],
  “hasMore”: false
}
```

b) Derive Access Set Name and its attributes using Access Set ID

### Example REST Call

http://{{host}}: {{port}}/api/boss/data/objects/XXXX/generalLedgerSetup/v1/dataAccessSetList? $filter=accessSetId=‘500’

### Example Response:

```
{
  “items”: [
    {
    “accessSetId”: “500”,
    “name”: “Vision Foods - USA Ledger”,
    “securitySegmentCode”: “F”,
    “automaticallyCreatedFlag”: true,
    “periodSetName”: “Vision Foods US”,
    “accountedPeriodType”: “MONTH8798351490”,
    “chartOfAccountsId”: “54604”,
  ],
  “hasMore”: false
}
```

c) Analytic View name

### Example Query to Fetch AV

select * from fun_av_metadata
where coa_id=‘54604’
and accounting_calendar_id=‘101234567806011’
and active_flag=‘Y’;

### Example Chart of Accounts ‘VF_USA_Accounting_Flexfield’ Structure

Chart of Accounts details

```
{
  “vfCompany”: {
    “SegmentName”:“Company”,
    “LabelCode”: “GL_BALANCING”,
    “SequenceNumber”: 1,
    “TreeCode”: “ALL VF COMPANIES”,
    “AllValuesHierarchy”:“vFCompanyHierarchy”,
    “ActiveHierarchy”: “companyAllVFCompaniesV2Hierarchy”
  },
  “vfCostCenter”: {
    “SegmentName”:“Cost Center”,
    “LabelCode”: “FA_COST_CTR, GL_MANAGEMENT, GL_SECONDARY_TRACKING”,
    “SequenceNumber”: 2,
    “TreeCode”:“ALL VF COST CENTERS”,
    “AllValuesHierarchy”:“vFCostCenterHierarchy”,
    “ActiveHierarchy”: “allVFCostCentersV1Hierarchy”
  },
  “vfProgram”: {
    “SegmentName”:“Program”,
    “SequenceNumber”: 3,
    “TreeCode”: “ALL VF PROGRAMS”,
    “AllValuesHierarchy”:“vFProgramHierarchy”,
    “ActiveHierarchy”: “allVFProgramsv1Hierarchy”
  },
  “vfLocation”: {
    “SegmentName”:“Location”,
    “SequenceNumber”: 4,
    “TreeCode”: “ALL VF LOCATIONS”,
    “AllValuesHierarchy”:“vFLocationHierarchy”
    “ActiveHierarchy”: “allVFLocationsv1Hierarchy”
  },
  “vfAccount”: {
    “SegmentName”:“Account”,
    “LabelCode”: “GL_ACCOUNT”,
    “SequenceNumber”: 5,
    “TreeCode”:“ALL VF ACCOUNTS”,
    “AllValuesHierarchy”:“vFAccountHierarchy”
    “ActiveHierarchy”: “allVFAccountsv1Hierarchy”
  },
  “vfDivision”: {
    “SegmentName”:“Division”,
    “TreeCode”:“ALL VF DIVISIONS”,
    “SequenceNumber”: 6,
    “AllValuesHierarchy”:“vFDivisionHierarchy”
    “ActiveHierarchy”: “allVFDivisionsv1Hierarchy”
  },
  “vfProduct”: {
    “SegmentName”: “Product”,
    “TreeCode”:“ALL VF PRODUCTS”,
    “SequenceNumber”: 7,
    “AllValuesHierarchy”:“vFProductHierarchy”
    “ActiveHierarchy”: “allVFProductsv1Hierarchy”
  },
  “vfIntercompany”: {
    “SegmentName”:“Intercompany”,
    “LabelCode”: “GL_INTERCOMPANY”,
    “SequenceNumber”: 8,
    “TreeCode”:“ALL VF COMPANIES”,
    “AllValuesHierarchy”:“vFIntercompanyHierarchy”
    “ActiveHierarchy”: “intercompanyAllVFCompaniesV2Hierarchy”
  }
}
```

Example Logic to derive Chart of Accounts (COA) Structure
REST Call to Expand source
https://XXXXX.com/XXXXApi/latest/flexfields/runtime/x/describe?
x=http://XXXX.XXXX.com/XXXX &discrValue=54604

### Example Accounting Period Details of ‘Vision Foods US’ Calendar for 2 Years (Current Year and Prior Year)

Details

```
{
  “items”: [
    {
      “periodName”: “Oct-22”,
      “periodYear”: “2022”,
      “quarterNumber”: “1”,
      “quarterName”:“Qtr1-2022”
    },
    {
      “periodName”: “Nov-22”,
      “periodYear”: “2022”,
      “quarterNumber”: “1”,
      “quarterName”:“Qtr1-2022”
    },
    {
      “periodName”: “Dec-22”,
      “periodYear”: “2022”,
      “quarterNumber”: “1”,
      “quarterName”:“Qtr1-2022”
    },
    {
      “periodName”: “Jan-23”,
      “periodYear”: “2022”,
      “quarterNumber”: “2”,
      “quarterName”:“Qtr2-2022”
    },
    {
      “periodName”: “Feb-23”,
      “periodYear”: “2022”,
      “quarterNumber”: “2”,
      “quarterName”:“Qtr2-2022”
    },
    {
      “periodName”: “Mar-23”,
      “periodYear”: “2022”,
      “quarterNumber”: “2”,
      “quarterName”:“Qtr2-2022”
    },
    {
      “periodName”: “Apr-23”,
      “periodYear”: “2022”,
      “quarterNumber”: “3”,
      “quarterName”:“Qtr3-2022”
    },
    {
      “periodName”: “May-23”,
      “periodYear”: “2022”,
      “quarterNumber”: “3”,
      “quarterName”:“Qtr3-2022”
    },
    {
      “periodName”: “Jun-23”,
      “periodYear”: “2022”,
      “quarterNumber”: “3”,
      “quarterName”:“Qtr3-2022”
    },
    {
      “periodName”: “Jul-23”,
      “periodYear”: “2022”,
      “quarterNumber”: “4”,
      “quarterName”:“Qtr4-2022”
    },
    {
      “periodName”: “Aug-23”,
      “periodYear”: “2022”,
      “quarterNumber”: “4”,
      “quarterName”:“Qtr4-2022”
    },
    {
      “periodName”: “Sep-23”,
      “periodYear”: “2022”,
      “quarterNumber”: “4”,
      “quarterName”:“Qtr4-2022”
    },
    {
      “periodName”: “13_Sep-23”,
      “periodYear”: “2022”,
      “quarterNumber”: “4”,
      “quarterName”:“Qtr4-2022”
    },
    {
      “periodName”: “Oct-23”,
      “periodYear”: “2023”,
      “quarterNumber”: “1”,
      “quarterName”:“Qtr1-2023”
    },
    {
      “periodName”: “Nov-23”,
      “periodYear”: “2023”,
      “quarterNumber”: “1”,
      “quarterName”:“Qtr1-2023”
    },
    {
      “periodName”: “Dec-23”,
      “periodYear”: “2023”,
      “quarterNumber”: “1”,
      “quarterName”:“Qtr1-2023”
    },
    {
      “periodName”: “Jan-24”,
      “periodYear”: “2023”,
      “quarterNumber”: “2”,
      “quarterName”:“Qtr2-2023”
    },
    {
      “periodName”: “Feb-24”,
      “periodYear”: “2023”,
      “quarterNumber”: “2”,
      “quarterName”:“Qtr2-2023”
    },
    {
      “periodName”: “Mar-24”,
      “periodYear”: “2023”,
      “quarterNumber”: “2”,
      “quarterName”:“Qtr2-2023”
    },
    {
      “periodName”: “Apr-24”,
      “periodYear”: “2023”,
      “quarterNumber”: “3”,
      “quarterName”:“Qtr3-2023”
    },
    {
      “periodName”: “May-24”,
      “periodYear”: “2023”,
      “quarterNumber”: “3”,
      “quarterName”:“Qtr3-2023”
    },
    {
      “periodName”: “Jun-24”,
      “periodYear”: “2023”,
      “quarterNumber”: “3”,
      “quarterName”:“Qtr3-2023”
    },
    {
      “periodName”: “Jul-24”,
      “periodYear”: “2023”,
      “quarterNumber”: “4”,
      “quarterName”:“Qtr4-2023”
    },
    {
      “periodName”: “Aug-24”,
      “periodYear”: “2023”,
      “quarterNumber”: “4”,
      “quarterName”:“Qtr4-2023”
    },
    {
      “periodName”: “Sep-24”,
      “periodYear”: “2023”,
      “quarterNumber”: “4”,
      “quarterName”:“Qtr4-2023”
    },
    {
      “periodName”: “13_Sep-24”,
      “periodYear”: “2023”,
      “quarterNumber”: “4”,
      “quarterName”:“Qtr4-2023”
    }
  ],
  “hasMore”: false
}
```

### Example Logic to Derive Accounting Period Details

1. Get period year for current Date using sysdate.

### Example REST Call

http://{{host}}: {{port}}/api/boss/data/objects/ora/XXXX/structure/v1/accountingPeriods?
$fields-periodName, periodYear, quarterNumber, startDate, endDate, yearStartDate, quarterStartDat e& $filter-calendar [periodSetName=‘Vision Foods US’ AND
periodType=‘MONTH8798351490’] and (startDate <=‘<sysdate>’ and endDate>=‘<sysdate>’)
E.g Response:

```
{
  “items”: [
    {
      “periodName”: “Jul-24”,
      “periodYear”: “2023”,
      “quarterNumber”: “4”,
      “quarterName”:“Qtr4-2023”
    }
  ],
  “hasMore”: false
}
```

2. Using periodYear, get all the periods for current and prior year

### Example REST Call

http://XXXX.com: XXXX/X/accountingPeriods?$fields=periodName, periodYear, quarterNumber, startDate, endDate, yearStartDate, quarterStartDate&$filter-calendar [periodSetName=‘Vision Foods US’ AND periodType=‘MONTH8798351490’] and periodYear in (‘2022’,‘2023’)
   Example Derived values from User Input <Dynamic>

### Assumptions

Proper noun index (vector embeddings) includes the below information
   Chart of Account segment values, its descriptions (description is language specific) and corresponding lookups.
      Lookups: Financial Category, Account Type
   Ledger Names and its description
   Currency code and its meaning (Meaning is language specific)
   Amount Type lookup code and meaning
   Currency Type lookup and meaning.
Search on Proper noun index will be with current chart of accounts context
Step 1: Tokenize the user input and perform semantic search against proper noun index to derive various dimension values of Analytic View
glbalanceav dimension values derived from given user input
   ledgerHiearchy.memberName:{None}
   currencyHierarchy.memberName:{None}
   accountingPeriodHiearchy.memberName:{None}.currencyTypeHierarchy.memberName:{None}
   Chart of Accounts dimensions involved:{vfCostCenter, vfAccount}
      Dimension Values:
         {“Dimension”: “vfCostCenter”}
         {“Dimension”: “vfAccount”, Value: “41000”, Description: “Total Net Trade Revenue”, SummaryFlag: “Y”}
         NOTE: 41000 corresponds to trade revenue
Step 2: If Ledger Name is not provided in the User Input, derive the Ledger(s) assigned to the Current Data Access set.

Note that one or more ledgers can be assigned to a Data Access Set
Ledgers assigned to current access set: Vision Foods-USA Ledger
   ledgerHierarchy.$memberDescription=‘Vision Foods-USA Ledger’
Ledger Currency: USD
   currencyHierarchy.$memberName=‘USD’
   Logic to derive ledgers assigned to Data Access Set
   select access_set_id, lgr.ledger_id, lgr.name, lgr.currency_code from fusion.gl_access_set_ledgers das, fusion.gl_ledgers 1 gr where access_set_id=<profile_option_value> and das.ledger_id=1 gr.ledger_id
Step 3: If period context is not available in user input, use the Accounting Calendar information derived above to derive the value for Accounting Period dimension
   For the current user input, period context is not given, below values may be derived based on the Accounting Calendar information.
   Period Context: (QoQ resolves to Current and Prior Quarter)
      accountingPeriodHierarchy.$memberName: (‘Qtr4-2023’,‘Qtr3-2023’)
         Current Period: August-24
         Current Quarter: Qtr4-2023
         Current Year: 2023
         Prior Period: July-24
         Prior Quarter: Qtr3-2023
         Prior Year: 2022
Step 4: Derive currency type based on the currency code
   currencyTypeHierarchy.$memberName=‘Total’
   Example logic to derive currencyType
      If currency code is same as ledger currency, then currency Type as ‘Total’
      If no currency code is specified, we'll use the ledger currency and currencyType as ‘Total’
      If given currency code is different from ledger currency, then currencyType will be ‘Entered’
Step 5: Identify the hierarchies to be used for Chart of Accounts dimensions in filter criteria

### Example Logic to Derive Hierarchies and Respective Values

If one or more parent values are derived from vector search, choose the top most value

### Parent Values

curl--location ‘http://X.X.X.X: XXXX/X/allvfaccountsvlhierarchy
$fields: $memberName,$levelName,$memberDescription
$filter: $memberName IN (<all parent values where we got a match from proper noun index search>)
$sortBy: $levelName
$limit: N
   If only matching child Values are found, fetch results for all values

### Only Child Values

curl--location ‘http://X.X.X.X: XXXX/X/vfaccountshierarchy
$fields: $memberName, $memberDescription
$filter: $memberName IN (<all child values where we got a match from proper noun index search>)
For the current user input,
   Account segment
      UserDefinedHierarchyName: “allVFAccountsv1Hierarchy”
      memberName: “41000”
   Company segment (Primary Balancing Segment)
      UserDefinedHierarchyName: “vFCompanyHierarchy”
   Cost Center segment
      UserDefinedHierarchyName: “vFCostCenterHierarchy”
Step 6: Identify Measures for the given user input
   Derived measure is endingBalanceQtdQr.
   Logic to derive measure

### Example BOSS SQL Semantics <Dynamic>

### BQL:

Field Projection: $fields: ledgerHierarchy.$memberName, currencyHierarchy.$memberName, accountingPeriodHierarchy.$memberName, vFCompanyHiera rchy.$memberName, vFCompanyHierarchy.$memberDescription, vFCostCenterHierarchy.$mem berName, vFCostCenterHierarchy.$memberDescription, all VF Accountsv1Hierarchy.$memberNa me, all VF Accountsv1Hierarchy.$memberDescription, endingBalanceQtdQr

### Filter Criteria:

$filter: allVFAccountsv1Hierarchy.$memberName=‘41000’ AND
ledgerHierarchy.$memberDescription=‘Vision Foods-USA Ledger’ AND accountingPeriodHierarchy.$memberName in (‘Qtr3-2023’,‘Qtr4-2023’) AND currencyHierarchy.$memberName=‘USD’ AND currencyTypeHierarchy.$memberName=‘Total’

### Example Output:

| | | | | | Amount |
|---|---|---|---|---|---|
| Ledger | Period | Company | Cost Center | Account | (USD) |
| 1225 - Vision | Qtr4- | 3111 - Vision | 110 - R&D US | 41000- Total | 1410305.41 |
| Foods - USA | 2023 | Foods | | Net Trade | |
| Ledger | | Marketing - US | | Revenue | |
| 1225 - Vision | Qtr4- | 3111 - Vision | 311 - Sales & | 41000- Total | 967299.41 |
| Foods - USA | 2023 | Foods | Marketing US | Net Trade | |
| Ledger | | Marketing - US | | Revenue | |
| 1225 - Vision | Qtr3- | 3111 - Vision | 112 - R&D | 41000- Total | 1255862.04 |
| Foods - USA | 2023 | Foods | Canada | Net Trade | |
| Ledger | | Marketing - US | | Revenue | |
| 1225 - Vision | Qtr3- | 3111 - Vision | 312 - Sales & | 41000- Total | 1674482.68 |
| Foods - USA | 2023 | Foods | Marekting | Net Trade | |
| Ledger | | Marketing - US | CAD | Revenue | |

### Computer System Architecture

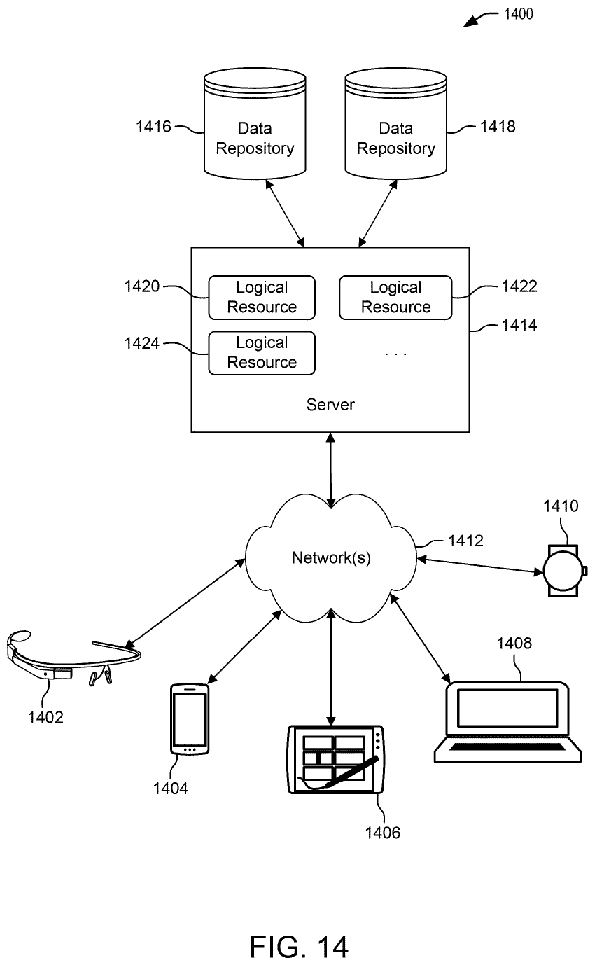

FIG. 14 depicts a simplified diagram of a distributed system 1400 for implementing an embodiment. In the illustrated embodiment, distributed system 1400 includes one or more client computing devices 1402, 1404, 1406, 1408, and/or 1410 coupled to a server 1414 via one or more communication networks 1412. Clients computing devices 1402, 1404, 1406, 1408, and/or 1410 may be configured to execute one or more applications.

In various aspects, server 1414 may be adapted to run one or more services or software applications that enable techniques for using structured data return template(s) for triggering application functionality and/or using information about item(s) of data selected in a user session to enrich a prompt to a large language model for determining a data-driven response to a user request.

In certain aspects, server 1414 may also provide other services or software applications that can include non-virtual and virtual environments. In some aspects, these services may be offered as web-based or cloud services, such as under a Software as a Service (SaaS) model to the users of client computing devices 1402, 1404, 1406, 1408, and/or 1410. Users operating client computing devices 1402, 1404, 1406, 1408, and/or 1410 may in turn utilize one or more client applications to interact with server 1414 to utilize the services provided by these components.

In the configuration depicted in FIG. 14, server 1414 may include one or more components 1420, 1422 and 1424 that implement the functions performed by server 1414. These components may include software components that may be executed by one or more processors, hardware components, or combinations thereof. It should be appreciated that various different system configurations are possible, which may be different from distributed system 1400. The embodiment shown in FIG. 14 is thus one example of a distributed system for implementing an embodiment system and is not intended to be limiting.

Users may use client computing devices 1402, 1404, 1406, 1408, and/or 1410 for techniques for using structured data return template(s) for triggering application functionality and/or using information about item(s) of data selected in a user session to enrich a prompt to a large language model for determining a data-driven response to a user request in accordance with the teachings of this disclosure. A client device may provide an interface that enables a user of the client device to interact with the client device. The client device may also output information to the user via this interface. Although FIG. 14 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOSx, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1412 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1412 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth™, and/or any other wireless protocol), and/or any combination of these and/or other networks.

Server 1414 may be composed of one or more general purpose computers, specialized server computers (including, by way of example, PC (personal computer) servers, UNIX® servers, LINUX® servers, mid-range servers, mainframe computers, rack-mounted servers, etc.), server farms, server clusters, a Real Application Cluster (RAC), database servers, or any other appropriate arrangement and/or combination. Server 1414 can include one or more virtual machines running virtual operating systems, or other computing architectures involving virtualization such as one or more flexible pools of logical storage devices that can be virtualized to maintain virtual storage devices for the server. In various aspects, server 1414 may be adapted to run one or more services or software applications that provide the functionality described in the foregoing disclosure.

The computing systems in server 1414 may run one or more operating systems including any of those discussed above, as well as any commercially available server operating system. Server 1414 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1414 may include one or more applications to analyze and consolidate data feeds and/or event updates received from users of client computing devices 1402, 1404, 1406, 1408, and/or 1410. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1414 may also include one or more applications to display the data feeds and/or real-time events via one or more display devices of client computing devices 1402, 1404, 1406, 1408, and/or 1410.

Distributed system 1400 may also include one or more data repositories 1416, 1418. These data repositories may be used to store data and other information in certain aspects. For example, one or more of the data repositories 1416, 1418 may be used to store information for techniques for using structured data return template(s) for triggering application functionality and/or using information about item(s) of data selected in a user session to enrich a prompt to a large language model for determining a data-driven response to a user request. Data repositories 1416, 1418 may reside in a variety of locations. For example, a data repository used by server 1414 may be local to server 1414 or may be remote from server 1414 and in communication with server 1414 via a network-based or dedicated connection. Data repositories 1416, 1418 may be of different types. In certain aspects, a data repository used by server 1414 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1416, 1418 may also be used by applications to store application data. The data repositories used by applications may be of different types such as, for example, a key-value store repository, an object store repository, or a general storage repository supported by a file system.

In one embodiment, server 1414 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

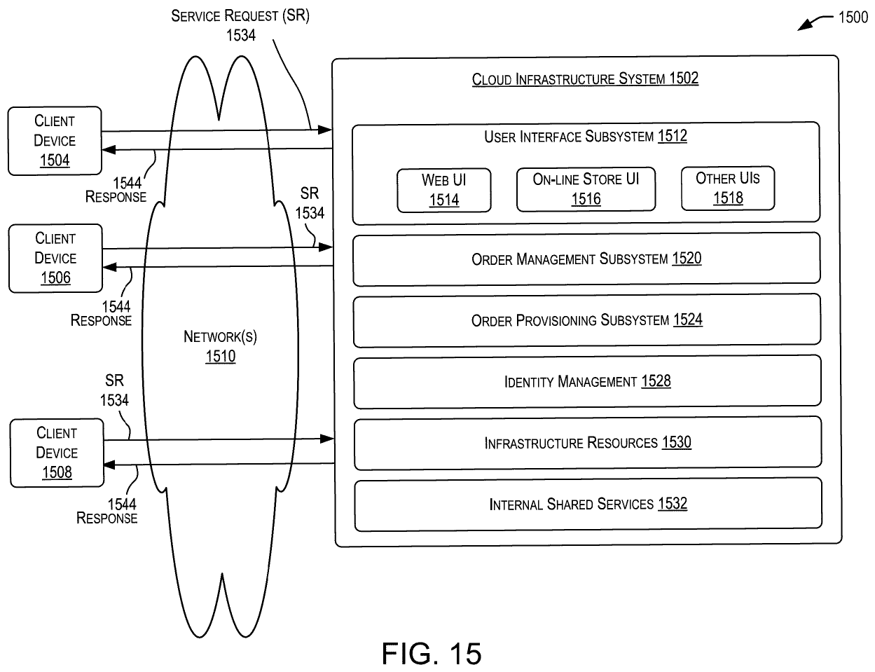

FIG. 15 is a simplified block diagram of a cloud-based system environment in which structured data return template(s) are used for triggering application functionality and/or information about item(s) of data selected in a user session is used to enrich a prompt to a large language model for determining a data-driven response to a user request, in accordance with certain aspects. In the embodiment depicted in FIG. 15, cloud infrastructure system 1502 may provide one or more cloud services that may be requested by users using one or more client computing devices 1504, 1506, and 1508. Cloud infrastructure system 1502 may comprise one or more computers and/or servers that may include those described above for server 1414. The computers in cloud infrastructure system 1502 may be organized as general purpose computers, specialized server computers, server farms, server clusters, or any other appropriate arrangement and/or combination.

Network(s) 1510 may facilitate communication and exchange of data between clients 1504, 1506, and 1508 and cloud infrastructure system 1502. Network(s) 1510 may include one or more networks. The networks may be of the same or different types. Network(s) 1510 may support one or more communication protocols, including wired and/or wireless protocols, for facilitating the communications.

The embodiment depicted in FIG. 15 is only one example of a cloud infrastructure system and is not intended to be limiting. It should be appreciated that, in some other aspects, cloud infrastructure system 1502 may have more or fewer components than those depicted in FIG. 15, may combine two or more components, or may have a different configuration or arrangement of components. For example, although FIG. 15 depicts three client computing devices, any number of client computing devices may be supported in alternative aspects.

The term cloud service is generally used to refer to a service that is made available to users on demand and via a communication network such as the Internet by systems (e.g., cloud infrastructure system 1502) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1510 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1502 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1502 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1502. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1502. Cloud infrastructure system 1502 then performs processing to provide the services requested in the tenant's subscription order. Cloud infrastructure system 1502 may be configured to provide one or even multiple cloud services.

Cloud infrastructure system 1502 may provide the cloud services via different deployment models. In a public cloud model, cloud infrastructure system 1502 may be owned by a third party cloud services provider and the cloud services are offered to any general public tenant, where the tenant can be an individual or an enterprise. In certain other aspects, under a private cloud model, cloud infrastructure system 1502 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1502 and the services provided may be shared by several organizations in a related community. Various other models such as hybrids of the above mentioned models may also be used.

Client computing devices 1504, 1506, and 1508 may be of different types (such as devices 1402, 1404, 1406, and 1408 depicted in FIG. 14) and may be capable of operating one or more client applications. A user may use a client device to interact with cloud infrastructure system 1502, such as to request a service provided by cloud infrastructure system 1502.

In some aspects, the processing performed by cloud infrastructure system 1502 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1502 for determining the intent of an utterance. The data used for this analysis may include structured data (e.g., data stored in a database or structured according to a structured model) and/or unstructured data (e.g., data blobs (binary large objects)).

As depicted in the embodiment in FIG. 15, cloud infrastructure system 1502 may include infrastructure resources 1530 that are utilized for facilitating the provision of various cloud services offered by cloud infrastructure system 1502. Infrastructure resources 1530 may include, for example, processing resources, storage or memory resources, networking resources, and the like.

In certain aspects, to facilitate efficient provisioning of these resources for supporting the various cloud services provided by cloud infrastructure system 1502 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1502 may itself internally use services 1532 that are shared by different components of cloud infrastructure system 1502 and which facilitate the provisioning of services by cloud infrastructure system 1502. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1502 may comprise multiple subsystems. These subsystems may be implemented in software, or hardware, or combinations thereof. As depicted in FIG. 15, the subsystems may include a user interface subsystem 1512 that enables users of cloud infrastructure system 1502 to interact with cloud infrastructure system 1502. User interface subsystem 1512 may include various different interfaces such as a web interface 1514, an online store interface 1516 where cloud services provided by cloud infrastructure system 1502 are advertised and are purchasable by a consumer, and other interfaces 1518. For example, a tenant may, using a client device, request (service request 1534) one or more services provided by cloud infrastructure system 1502 using one or more of interfaces 1514, 1516, and 1518. For example, a tenant may access the online store, browse cloud services offered by cloud infrastructure system 1502, and place a subscription order for one or more services offered by cloud infrastructure system 1502 that the tenant wishes to subscribe to. The service request may include information identifying the tenant and one or more services that the tenant desires to subscribe to. For example, a tenant may place a subscription order for a chatbot related service offered by cloud infrastructure system 1502. As part of the order, the client may provide information identifying the input (e.g. utterances).

In certain aspects, such as the embodiment depicted in FIG. 15, cloud infrastructure system 1502 may comprise an order management subsystem (OMS) 1520 that is configured to process the new order. As part of this processing, OMS 1520 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1520 may then invoke the order provisioning subsystem (OPS) 1524 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1524 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1502 may send a response or notification 1544 to the requesting tenant to indicate when the requested service is now ready for use. In some instances, information (e.g., a link) may be sent to the tenant that enables the tenant to start using and availing the benefits of the requested services.

Cloud infrastructure system 1502 may provide services to multiple tenants. For each tenant, cloud infrastructure system 1502 is responsible for managing information related to one or more subscription orders received from the tenant, maintaining tenant data related to the orders, and providing the requested services to the tenant or clients of the tenant. Cloud infrastructure system 1502 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1502 may provide services to multiple tenants in parallel. Cloud infrastructure system 1502 may store information for these tenants, including possibly proprietary information. In certain aspects, cloud infrastructure system 1502 comprises an identity management subsystem (IMS) 1528 that is configured to manage tenant's information and provide the separation of the managed information such that information related to one tenant is not accessible by another tenant. IMS 1528 may be configured to provide various security-related services such as identity services, such as information access management, authentication and authorization services, services for managing tenant identities and roles and related capabilities, and the like.

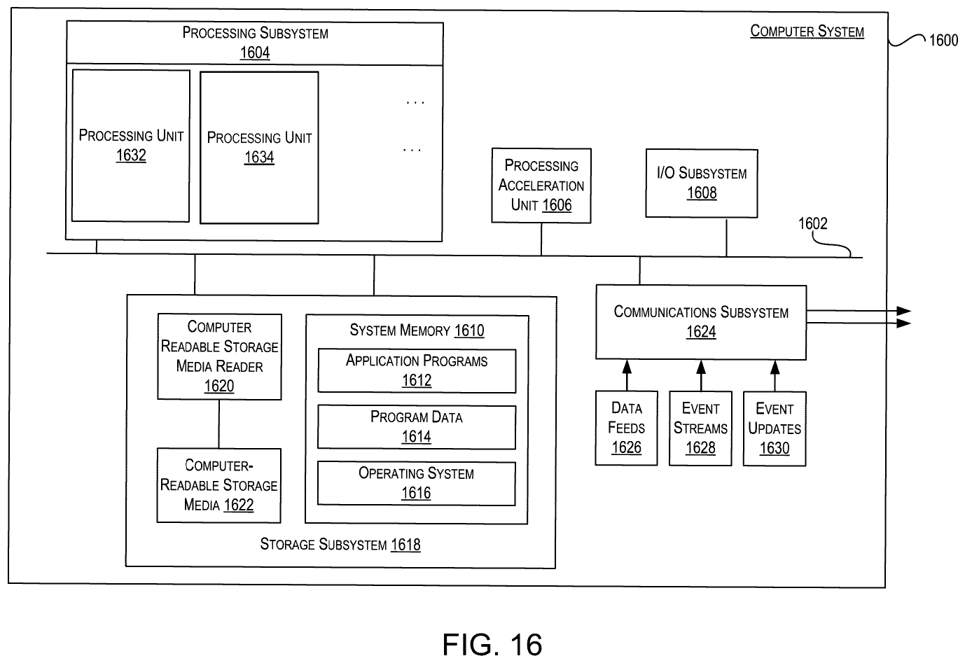

FIG. 16 illustrates an exemplary computer system 1600 that may be used to implement certain aspects. As shown in FIG. 16, computer system 1600 includes various subsystems including a processing subsystem 1604 that communicates with a number of other subsystems via a bus subsystem 1602. These other subsystems may include a processing acceleration unit 1606, an I/O subsystem 1608, a storage subsystem 1618, and a communications subsystem 1624. Storage subsystem 1618 may include non-transitory computer-readable storage media including storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative aspects of the bus subsystem may utilize multiple buses. Bus subsystem 1602 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1604 controls the operation of computer system 1600 and may comprise one or more processors, application specific integrated circuits (ASICs), or field programmable gate arrays (FPGAs). The processors may be single core or multicore processors. The processing resources of computer system 1600 can be organized into one or more processing units 1632, 1634, etc. A processing unit may include one or more processors, one or more cores from the same or different processors, a combination of cores and processors, or other combinations of cores and processors. In some aspects, processing subsystem 1604 can include one or more special purpose co-processors such as graphics processors, digital signal processors (DSPs), or the like. In some aspects, some or all of the processing units of processing subsystem 1604 can be implemented using customized circuits, such as application specific integrated circuits (ASICs), or field programmable gate arrays (FPGAs).

In some aspects, the processing units in processing subsystem 1604 can execute instructions stored in system memory 1610 or on computer readable storage media 1622. In various aspects, the processing units can execute a variety of programs or code instructions and can maintain multiple concurrently executing programs or processes. At any given time, some or all of the program code to be executed can be resident in system memory 1610 and/or on computer-readable storage media 1622 including potentially on one or more storage devices. Through suitable programming, processing subsystem 1604 can provide various functionalities described above. In instances where computer system 1600 is executing one or more virtual machines, one or more processing units may be allocated to each virtual machine.

In certain aspects, a processing acceleration unit 1606 may optionally be provided for performing customized processing or for off-loading some of the processing performed by processing subsystem 1604 so as to accelerate the overall processing performed by computer system 1600.

I/O subsystem 1608 may include devices and mechanisms for inputting information to computer system 1600 and/or for outputting information from or via computer system 1600. In general, use of the term input device is intended to include all possible types of devices and mechanisms for inputting information to computer system 1600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1600 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1618 provides a repository or data store for storing information and data that is used by computer system 1600. Storage subsystem 1618 provides a tangible non-transitory computer-readable storage medium for storing the basic programming and data constructs that provide the functionality of some aspects. Storage subsystem 1618 may store software (e.g., programs, code modules, instructions) that when executed by processing subsystem 1604 provides the functionality described above. The software may be executed by one or more processing units of processing subsystem 1604. Storage subsystem 1618 may also provide a repository for storing data used in accordance with the teachings of this disclosure.

Storage subsystem 1618 may include one or more non-transitory memory devices, including volatile and non-volatile memory devices. As shown in FIG. 16, storage subsystem 1618 includes a system memory 1610 and a computer-readable storage media 1622. System memory 1610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1600, such as during start-up, may typically be stored in the ROM. The RAM typically contains data and/or program modules that are presently being operated and executed by processing subsystem 1604. In some implementations, system memory 1610 may include multiple different types of memory, such as static random access memory (SRAM), dynamic random access memory (DRAM), and the like.

By way of example, and not limitation, as depicted in FIG. 16, system memory 1610 may load application programs 1612 that are being executed, which may include various applications such as Web browsers, mid-tier applications, relational database management systems (RDBMS), etc., program data 1614, and an operating system 1616. By way of example, operating system 1616 may include various versions of Microsoft Windows*, Apple Macintosh®, and/or Linux operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1622 may store programming and data constructs that provide the functionality of some aspects. Computer-readable media 1622 may provide storage of computer-readable instructions, data structures, program modules, and other data for computer system 1600. Software (programs, code modules, instructions) that, when executed by processing subsystem 1604 provides the functionality described above, may be stored in storage subsystem 1618. By way of example, computer-readable storage media 1622 may include non-volatile memory such as a hard disk drive, a magnetic disk drive, an optical disk drive such as a CD ROM, digital video disc (DVD), a Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1618 may also include a computer-readable storage media reader 1620 that can further be connected to computer-readable storage media 1622. Reader 1620 may receive and be configured to read data from a memory device such as a disk, a flash drive, etc.

In certain aspects, computer system 1600 may support virtualization technologies, including but not limited to virtualization of processing and memory resources. For example, computer system 1600 may provide support for executing one or more virtual machines. In certain aspects, computer system 1600 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1600. Accordingly, multiple operating systems may potentially be run concurrently by computer system 1600.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to establish a communication channel to one or more client devices via the Internet for receiving and sending information from and to the client devices. For example, the communications subsystem may be used to transmit a response to a user regarding the inquiry for a chatbot.

Communications subsystem 1624 may support both wired and/or wireless communication protocols. For example, in certain aspects, communications subsystem 1624 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1624 can provide wired network connectivity (e.g., Ethernet) in addition to or instead of a wireless interface.

Communications subsystem 1624 can receive and transmit data in various forms. For example, in some aspects, in addition to other forms, communications subsystem 1624 may receive input communications in the form of structured and/or unstructured data feeds 1626, event streams 1628, event updates 1630, and the like. For example, communications subsystem 1624 may be configured to receive (or send) data feeds 1626 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1624 may be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1624 may also be configured to communicate data from computer system 1600 to other computer systems or networks. The data may be communicated in various different forms such as structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1600 depicted in FIG. 16 is intended only as a specific example. Many other configurations having more or fewer components than the system depicted in FIG. 16 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a natural language user request received in a user session with an application, wherein the natural language user request is stored in association with one or more items of data that have been selected in the user session;
determining that a particular structured data return template, of a plurality of stored structured data return templates, is relevant to the request; wherein the particular structured data return template is configured to trigger a particular item of application functionality that is different than one or more other items of application functionality which one or more other structured data return templates of the plurality of stored structured data return templates are configured to trigger;
generating a prompt by adding the particular structured data return template for triggering the particular item of application functionality, structured text representing the one or more items of data in a multidimensional context, and the natural language user request to a prompt template;
prompting a large language model with the prompt;
receiving a result of the prompt, the result comprising a data structure conforming to the structured data return template and that is based at least in part on the one or more items of data in the multidimensional context; and
triggering the particular item of application functionality based at least in part on the data structure;
causing display of information indicating the particular item of application functionality has been triggered.

2. The computer-implemented method of claim 1, wherein the one or more items of data are selected by being highlighted in the user session as the user request is submitted as text input.

3. The computer-implemented method of claim 1, wherein the one or more items of data are selected by being dragged into an input field, the method further comprising:
causing display, in the input field, of a graphical object representing the one or more items of data, the graphical object indicating that information about the one or more items of data are included with the user request upon submission; and
receiving the user request as text added to the input field.

4. The computer-implemented method of claim 1, wherein the particular structured data return template is stored separately from the prompt template, and wherein the prompt template supports a plurality of different structured data return templates that are selectable depending on the user request.

5. The computer-implemented method of claim 1, further comprising determining that the particular structured data return template is relevant to the user request based at least in part on a semantic similarity of the user request to a content embedding stored for matching the particular structured data return template to user requests.

6. The computer-implemented method of claim 1, further comprising determining that the particular structured data return template is relevant to the user request based at least in part on another prompt to the large language model, the other prompt asking which of a specified set of different items of application functionality the user request is attempting to trigger.

7. The computer-implemented method of claim 1, further comprising retrieving the structured text representing the one or more items of data based at least in part on a REST call to access a data repository.

8. The computer-implemented method of claim 1, wherein the data structure conforming to the particular structured data return template triggers a REST call to access a data repository and retrieve one or more data values to perform one or more operations on the one or more data values.

9. The computer-implemented method of claim 1, wherein the data structure conforming to the particular structured data return template triggers a REST call to create one or more objects in a data repository and navigate to one or more user interfaces to analyze the one or more created objects.

10. The computer-implemented method of claim 1, wherein the data structure conforming to the particular structured data return template triggers creation of one or more objects in a data repository and causes an option to be displayed for confirming the one or more objects.

11. The computer-implemented method of claim 1, wherein the accessing the natural language user request is performed by a supervisor agent; and wherein the generating the prompt and the prompting the large language model are performed by a particular worker agent based on information provided by the supervisor agent; the method further comprising: selecting one or more worker agents, including the particular worker agent, of a plurality of worker agents for the natural language user request based at least in part on a context of the natural language user request.

12. The computer-implemented method of claim 11, wherein the supervisor agent is a ledger insights monitor supervisor agent that tracks criteria and governs insights, and wherein the one or more worker agents comprise:
a ledger insights tracker worker agent that monitors insights criteria and generates insights and alerts, and
an insights explorer worker agent that generates one or more views showing data sets of a particular granularity;
wherein the causing display of the information comprises causing display of the one or more views.

13. A computer-program product comprising one or more non-transitory machine-readable storage media, including stored instructions configured to cause a computing system to perform a set of actions including:
accessing a natural language user request received in a user session with an application, wherein the natural language user request is stored in association with one or more items of data that have been are selected in the user session;
determining that a particular structured data return template, of a plurality of stored structured data return templates, is relevant to the request; wherein the particular structured data return template is configured to trigger a particular item of application functionality that is different than one or more other items of application functionality which one or more other structured data return templates of the plurality of stored structured data return templates are configured to trigger;
generating a prompt by adding the particular structured data return template for triggering the particular item of application functionality, structured text representing the one or more items of data in a multidimensional context, and the natural language user request to a prompt template;
prompting a large language model with the prompt;
receiving a result of the prompt, the result comprising a data structure conforming to the structured data return template and that is based at least in part on the one or more items of data in the multidimensional context; and
triggering the particular item of application functionality based at least in part on the data structure;
causing display of information indicating the particular item of application functionality has been triggered.

14. The computer-program product of claim 13, wherein the one or more items of data are selected by being highlighted in the user session as the user request is submitted as text input.

15. The computer-program product of claim 13, wherein the one or more items of data are selected by being dragged into an input field, the set of actions further including:
causing display, in the input field, of a graphical object representing the one or more items of data, the graphical object indicating that information about the one or more items of data are included with the user request upon submission; and
receiving the user request as text added to the input field.

16. The computer-program product of claim 13, wherein the particular structured data return template is stored separately from the prompt template, and wherein the prompt template supports a plurality of different structured data return templates that are selectable depending on the user request.

17. The computer-program product of claim 13, the set of actions further including determining that the particular structured data return template is relevant to the user request based at least in part on a semantic similarity of the user request to a content embedding stored for matching the particular structured data return template to user requests.

18. The computer-program product of claim 13, wherein the accessing the natural language user request is performed by a supervisor agent; and wherein the generating the prompt and the prompting the large language model are performed by a particular worker agent based on information provided by the supervisor agent; and wherein the set of actions further includes: selecting one or more worker agents, including the particular worker agent, of a plurality of worker agents for the natural language user request based at least in part on a context of the natural language user request.

19. The computer-program product of claim 18, wherein the supervisor agent is a ledger insights monitor supervisor agent that tracks criteria and governs insights, and wherein the one or more worker agents comprise:
a ledger insights tracker worker agent that monitors insights criteria and generates insights and alerts, and
an insights explorer worker agent that generates one or more views showing data sets of a particular granularity;
wherein the causing display of the information comprises causing display of the one or more views.

20. A system comprising:
one or more processors;
one or more non-transitory computer-readable media storing instructions, which, when executed by the system, cause the system to perform a set of actions including:
accessing a natural language user request received in a user session with an application, wherein the natural language user request is stored in association with one or more items of data that have been are selected in the user session;
determining that a particular structured data return template, of a plurality of stored structured data return templates, is relevant to the request; wherein the particular structured data return template is configured to trigger a particular item of application functionality that is different than one or more other items of application functionality which one or more other structured data return templates of the plurality of stored structured data return templates are configured to trigger;
generating a prompt by adding the particular structured data return template for triggering the particular item of application functionality, structured text representing the one or more items of data in a multidimensional context, and the natural language user request to a prompt template;
prompting a large language model with the prompt;
receiving a result of the prompt, the result comprising a data structure conforming to the structured data return template and that is based at least in part on the one or more items of data in the multidimensional context; and
triggering the particular item of application functionality based at least in part on the data structure;
causing display of information indicating the particular item of application functionality has been triggered.

21. The system of claim 20, wherein the one or more items of data are selected by being highlighted in the user session as the user request is submitted as text input.

22. The system of claim 20, wherein the one or more items of data are selected by being dragged into an input field, the set of actions further including:
causing display, in the input field, of a graphical object representing the one or more items of data, the graphical object indicating that information about the one or more items of data are included with the user request upon submission; and
receiving the user request as text added to the input field.

23. The system of claim 20, wherein the particular structured data return template is stored separately from the prompt template, and wherein the prompt template supports a plurality of different structured data return templates that are selectable depending on the user request.

24. The system of claim 20, the set of actions further including determining that the particular structured data return template is relevant to the user request based at least in part on a semantic similarity of the user request to a content embedding stored for matching the particular structured data return template to user requests.

25. The system of claim 20, wherein the accessing the natural language user request is performed by a supervisor agent; and wherein the generating the prompt and the prompting the large language model are performed by a particular worker agent based on information provided by the supervisor agent; and wherein the set of actions further includes: selecting one or more worker agents, including the particular worker agent, of a plurality of worker agents for the natural language user request based at least in part on a context of the natural language user request.

26. The system of claim 25, wherein the supervisor agent is a ledger insights monitor supervisor agent that tracks criteria and governs insights, and wherein the one or more worker agents comprise:
a ledger insights tracker worker agent that monitors insights criteria and generates insights and alerts, and
an insights explorer worker agent that generates one or more views showing data sets of a particular granularity;
wherein the causing display of the information comprises causing display of the one or more views.
